(19) United States
(12) Patent Application Publication
(10) Pub. No.: US 2024/0078877 A1
(43) Pub. Date: Mar. 7, 2024

(54) MULTI-LEVEL PROGRESSION WITHIN A SERIES OF SOFTWARE-BASED REEL EVENTS

(71) Applicant: Games Global Operations Limited, Douglas (IM)

(72) Inventors: Julia Aru, Tallinn (EE); Alex Bitterlin, New South Wales (AU); Gülce Naz Mert, Tallinn (EE); Bradley Johnson, Winnipeg (CA)

(21) Appl. No.: 18/453,906

(22) Filed: Aug. 22, 2023

(30) Foreign Application Priority Data
Aug. 31, 2022 (GB) 2212654.4

(51) Int. Cl. G07F 17/32

(52) U.S. Cl. CPC G07F 17/3267; G07F 17/3213; G07F 17/3223

(57) ABSTRACT

A method includes outputting, on a GUI while a processor operates in a first operating state (OS), one or more spins of a reel set and determining whether a first running total of displayed symbols exceeds a respective first threshold of a first and/or second reward system. The method includes outputting a reward because the first running total exceeds a respective first threshold of the reward systems. The method includes transitioning the processor from operating in the first OS to a second OS, and outputting, on a GUI while the processor operates in the second OS, one or more spins of the reel set for the second OS. The method includes determining whether a second running total of displayed symbols exceeds a respective second threshold of the first and/or second reward system, and outputting a reward because the second running total exceeds a respective second threshold of the reward systems.

### PRIORITY

This application claims priority under 35 U.S.C. § 119 to United Kingdom Patent Application No. 2212654.4 filed Aug. 31, 2022. United Kingdom Patent Application No. 2212654.4 is hereby incorporated by reference in its entirety.

### FIELD

This disclosure relates to a multi-level progression within a series of software-based reel events, including reel-based events having multiple, concurrently operating reward systems and/or multiple reel sets.

### BACKGROUND

Slot machines come in a variety of forms, including for example a mechanical slot machine. A mechanical slot machine can include one or more reels, each of which includes multiple symbols distributed around the circumference of the reel. When a slot machine with reel(s) is used, a user is allowed to spin the reels. Each reel then comes to rest, typically with either one of the symbols, or a space in between symbols, in alignment with a payline. A predefined winning symbol or a predefined combination of winning symbols that are aligned with the payline can result in the user receiving an award. In one example, the slot machine can include three reels, and the payline can be an imaginary, horizontal line disposed across a central portion of a window through which a portion of each of the three reels is visible.

As another example, a mechanical slot machine can present symbols in a matrix arrangement, with each symbol changing during a use of the mechanical slot machine. For example, the mechanical slot machine can have five columns and three rows of symbols, for a total of fifteen symbols. Such mechanical slot machines often have multiple pay lines, each being defined by a collection of positions within the matrix. For example, the mechanical slot machine can have three pay lines, each corresponding to one row of the matrix.

While slot machines were traditionally mechanical, modern slot machines often take the form of a computing system (e.g., a dedicated computing system located in a casino) that includes a graphical user interface (GUI), and that can emulate a mechanical slot machine. Despite such advances, there is a continuing need to improve how a computing system simulates a mechanical slot machine.

### Overview

The present application discloses embodiments including and/or related to systems, methods, and apparatus that provide improvements in computer-implemented technology by increasing the number and variety of possible outcomes based on a random selection of symbols, such as symbols that can be found on a mechanical slot machine.

In a first aspect, a computing system is provided. The computing system includes a processor and a computer-readable memory storing executable instructions. Execution of the executable instructions by the processor causes the computing system to perform functions. The functions include providing, by the processor, a graphical user interface including multiple symbol positions arranged in multiple rows and multiple columns. Each column of the multiple columns is arranged to depict a spinnable reel of a reel set. Each spinnable reel includes multiple different symbols from a set of symbols. The set of symbols includes a particular symbol. Additionally, the functions include outputting, on the graphical user interface while the processor operates in a first operating state, one or more spins of the reel set for the first operating state. The functions further include determining, by the processor based on the one or more spins of the reel set for the first operating state, a first running total of a number of times the particular symbol is displayed on the graphical user interface while the processor is operating in the first operating state. The functions additionally include determining, by the processor, whether the first running total exceeds one or more of a first threshold of a first reward system or a first threshold of a second reward system. The functions also include outputting, by the processor, at least one reward in response to the first running total exceeding one or more of the first threshold of the first reward system or the first threshold of the second reward system. The functions further include to transitioning, in response to the first running total exceeding the first threshold of the second reward system, the processor from operating in the first operating state to a second operating state. The functions also include outputting, on the graphical user interface while the processor operates in the second operating state, one or more spins of the reel set for the second operating state. Additionally, the functions include determining, by the processor based on the one or more spins of the reel set for the second operating state, a second running total of a number of times the particular symbol is displayed on the graphical user interface while the processor is operating in the second operating state. Furthermore, the functions include determining, by the processor, whether the second running total exceeds one or more of a second threshold of the first reward system or a second threshold of the second reward system. Furthermore still, the functions include outputting, by the processor, at least one reward in response to the second running total exceeding one or more of the second threshold of the first reward system or the second threshold of the second reward system.

In a second aspect, a method is provided. The method includes providing, by a processor, a graphical user interface including multiple symbol positions arranged in multiple rows and multiple columns. Each column of the multiple columns is arranged to depict a spinnable reel of a reel set. Each spinnable reel includes multiple different symbols from a set of symbols. The set of symbols includes a particular symbol. The method also includes outputting, on the graphical user interface while the processor operates in a first operating state, one or more spins of the reel set for the first operating state. The method further includes determining, by the processor based on the one or more spins of the reel set for the first operating state, a first running total of a number of times the particular symbol is displayed on the graphical user interface while the processor is operating in the first operating state. Additionally, the method includes determining, by the processor, whether the first running total exceeds one or more of a first threshold of a first reward system or a first threshold of a second reward system. The method also includes outputting, by the processor, at least one reward in response to the first running total exceeding one or more of the first threshold of the first reward system or the first threshold of the second reward system. The method further includes transitioning, in response to the first running total exceeding the first threshold of the second reward system, the processor from operating in the first operating state to a second operating state. Moreover, the method includes outputting, on the graphical user interface while the processor operates in the second operating state, one or more spins of the reel set for the second operating state. The method also includes determining, by the processor based on the one or more spins of the reel set for the second operating state, a second running total of a number of times the particular symbol is displayed on the graphical user interface while the processor is operating in the second operating state. Furthermore, the method includes determining, by the processor, whether the second running total exceeds one or more of a second threshold of the first reward system or a second threshold of the second reward system. Furthermore still, the method includes outputting, by the processor, at least one reward in response to the second running total exceeding one or more of the second threshold of the first reward system or the second threshold of the second reward system.

In a third aspect, a computer-readable memory is provided. The computer-readable memory has stored therein instructions executable by a processor to cause a computing system to perform functions. The functions include providing, by a processor, a graphical user interface including multiple symbol positions arranged in multiple rows and multiple columns. Each column of the multiple columns is arranged to depict a spinnable reel of a reel set. Each spinnable reel includes multiple different symbols from a set of symbols. The set of symbols includes a particular symbol. Additionally, the functions include outputting, on the graphical user interface while the processor operates in a first operating state, one or more spins of the reel set for the first operating state. The functions also include determining, by the processor based on the one or more spins of the reel set for the first operating state, a first running total of a number of times the particular symbol is displayed on the graphical user interface while the processor is operating in the first operating state. The functions further include determining, by the processor, whether the first running total exceeds one or more of a first threshold of a first reward system or a first threshold of a second reward system. The functions also include outputting, by the processor, at least one reward in response to the first running total exceeding one or more of the first threshold of the first reward system or the first threshold of the second reward system. The functions further include transitioning, in response to the first running total exceeding the first threshold of the second reward system, the processor from operating in the first operating state to a second operating state. The functions also include outputting, on the graphical user interface while the processor operates in the second operating state, one or more spins of the reel set for the second operating state. Additionally, the functions include determining, by the processor based on the one or more spins of the reel set for the second operating state, a second running total of a number of times the particular symbol is displayed on the graphical user interface while the processor is operating in the second operating state. Furthermore, the functions include determining, by the processor, whether the second running total exceeds one or more of a second threshold of the first reward system or a second threshold of the second reward system. Furthermore still, the functions include outputting, by the processor, at least one reward in response to the second running total exceeding one or more of the second threshold of the first reward system or the second threshold of the second reward system.

These aspects, as well as other embodiments, aspects, advantages, and alternatives will become apparent to those of ordinary skill in the art by reading the following detailed description, with reference where appropriate to the accompanying drawings. Further, this overview and other descriptions and figures provided herein are intended to illustrate embodiments using examples only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

The above, as well as additional, features will be better understood through the following illustrative and non-limiting detailed description of example embodiments, with reference to the appended drawings.

FIG. 1A is a block diagram of a machine, in accordance with the example embodiments.

FIG. 1B is a block diagram of a computing system, in accordance with the example embodiments.

FIG. 2 is a block diagram of two computing systems connected to one another via a computer network, in accordance with the example embodiments.

FIG. 3A, FIG. 3B, and FIG. 3C show data that can be stored in a memory, in accordance with the example embodiments.

FIG. 4 shows a graphical user interface, in accordance with the example embodiments.

FIG. 5 depicts a selected symbol set in a display, in accordance with the example embodiments.

FIG. 6 is a flow chart showing functions of a method, in accordance with the example embodiments.

FIG. 7A, FIG. 7B, and FIG. 7C show a display screen, in accordance with the example embodiments.

FIG. 8 is a block diagram of a computing system configured for multi-level progression within a series of software-based reel events, in accordance with the example embodiments.

FIG. 9A, FIG. 9B, FIG. 9C, FIG. 9D, and/or FIG. 9E is a flow chart showing functions of a method for multi-level progression within a series of software-based reel events, in accordance with the example embodiments.

All the figures are schematic, not necessarily to scale, and generally only show parts which are necessary to elucidate example embodiments, wherein other parts can be omitted or merely suggested.

### DETAILED DESCRIPTION

### I. Introduction

In this detailed description, several example embodiments are disclosed including, but not limited to, embodiments pertaining to performing aspects of an outcome event using a computing system (e.g., a server and/or a client computing system), a user device and/or a machine. The user device and/or the machine can be configured as and/or include a computing system. For purposes of this description, unless the context dictates otherwise, a user device or machine can include and/or be embodied as a computing system.

A computing system and/or a display screen of the computing system can display a variety of symbols during performance of an outcome event. A symbol displayed within a symbol-display-portion of the display screen during an outcome event can be replaced (upgraded) by another symbol. The replacement symbols can be used to determine an award for a winning outcome. A winning outcome can be based on symbols being displayed according to a pattern of symbols (e.g., a predefined pattern of symbols). The pattern can be defined as a payline of a line-type outcome event, or a payway of a ways-type outcome event. Unless the context of the specification dictates otherwise, an embodiment in which outcomes are based on paylines and/or a line-type outcome event, can instead be based on payways and/or a ways-type outcome event, and vice versa.

In a line-type outcome event, each payline is a pattern on reels or a matrix. The payline typically starts from a left-most reel and passes through adjacent reels until the payline reaches the right-most reel. The quantity of paylines active for a line-type outcome event can depend upon a payment and/or a selection made to perform the line-type outcome event.

In a ways-type outcome event, each payway includes a combination of matching symbols located on adjacent reels. The symbols can be in any position on one of the adjacent reel. As an example, for outcome events performed on a computing system having a display screen, the outcome events can be arranged with five reels and three rows such that there are 243 payways with three or more symbols possible. The quantity of payways active for a ways-type outcome event can depend upon a payment and/or selection made to perform the ways-type outcome event.

In accordance with the example embodiments, a pattern that results in an award can include a particular pattern that starts at either side of a symbol-display portion of a display (e.g., a left side or a right side). For example, in an embodiment in which the symbol-display portion includes a respective reel in five columns referred to as C1, C2, C3, C4, C5 as those columns are arranged from a left side of the symbol-display portion to a right side of the symbol portion, the particular pattern (e.g., a payline or payway) can include a pattern with a sufficient quantity and kind of symbols starting at column C1, or a pattern with a sufficient quantity and kind of symbols starting at column C5. For instance, if the sufficient quantity and kind of symbols equals three “K” symbols, then a pattern of “K” symbols in columns C1, C2, C3 or in columns C5, C4, C3 results in an award. Moreover, in some embodiments, a special symbol, such as a “Wild” symbol can take the place of the kind of symbol defined for the particular pattern. Other examples of the sufficient quantity and kind of symbols are possible.

Some of the described embodiments refer to multiple patterns (e.g., multiple particular patterns). In one respect, the multiple particular patterns can be multiple particular paylines. In another respect, the multiple particular patterns can be multiple particular payways. Moreover, a particular pattern can be a particular payline or a particular payway. Furthermore, a winning pattern can be a winning payline or a winning payway. Furthermore still, a horizontally extending pattern can be a horizontally extending payline or a horizontally extending payway. Similarly, a diagonally extending pattern can be a diagonally extending payline or a diagonally extending payway.

Moreover, displaying the symbols can include displaying an image of one or more reels or a matrix, together with animation effects to simulate a spin of the one or more reels, or a spin of the columns or rows of the matrix. A computer software program, which can reside in the computing system, can randomly select one or more symbols in response to a spin, and can display the selected one or more symbols on the display.

Additionally, an outcome event can be played over a computer-network, such as by a user using a client computing system that is connected to a server computing system over the computer-network. In this instance, the server computing system can cause the reels to spin and can send the resulting symbols to the client computing system for display.

Throughout this description, the articles “a” or “an” are used to introduce elements of the example embodiments. Any reference to “a” or “an” refers to “at least one” or “one or more,” and any reference to “the” refers to “the at least one” or “the one or more,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures can be used in combination with one another. Thus, the figures should be generally viewed as component aspects of one or more overall embodiments, with the understanding that not all illustrated features are necessary for each embodiment.

The systems, methods, and apparatus described in this description can carry out aspects of an outcome event that includes displaying symbols. These aspects can be incorporated into outcome events, in particular, outcome events performed in response to a payment. In one aspect, the systems, methods, and apparatus provide features that can enhance traditional outcome events (e.g., slot machines or other reel-type outcome events) by providing a user with additional opportunities to win the outcome event, thereby increasing the user's interest, anticipation, and excitement in connection with the outcome event. This can in turn benefit a casino or another entity that provides an outcome event with this feature. Indeed, outcome events are typically configured to have odds that favor the casino (sometimes referred to as the “house”). Accordingly, based on the law of averages, casinos often increase their profits simply by getting more users to use its computing system to perform more outcome events. Due to the provided features, users can be drawn in (e.g., from competing casinos that lack outcome events with such features) and they can play the outcome event often. The features can include data communications between a server computing system and a client computing system within a server-client based configuration.

### II. Example Architecture

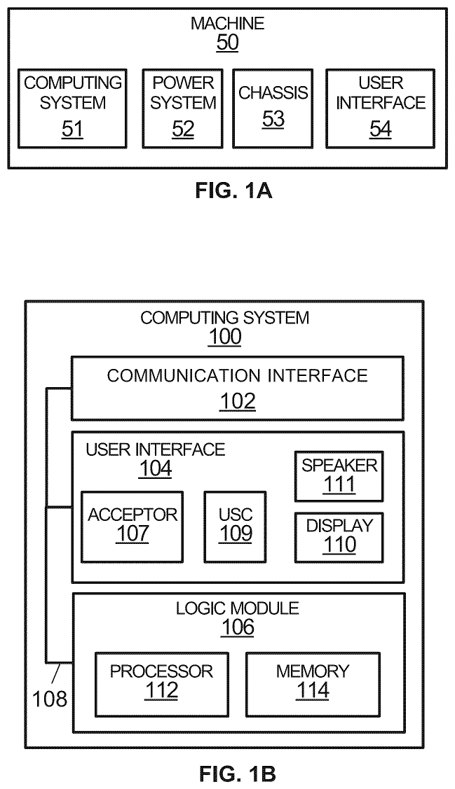

FIG. 1A is a block diagram of a machine 50, in accordance with the example embodiments. The machine 50 includes a computing system 51, a power system 52, a chassis 53, and/or a user interface 54. The machine 50 can be configured to perform a method or at least some functions of a method according to the example embodiments. In at least some embodiments, the computing system 51 can include at least a portion of one or more from among: the power system 52, the chassis 53, or the user interface 54.

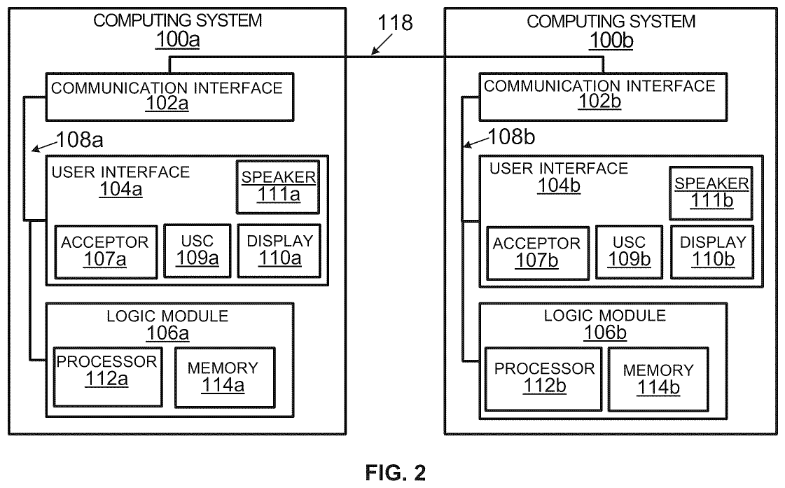

The computing system 51 can include a processor and a memory storing program instructions executable by the processor to perform a method or at least some functions of a method according to the example embodiments. As an example, the computing system 51 can be arranged as and/or include components of any computing system described in this description and/or shown in the drawings. In particular, the computing system 51 can be arranged as and/or include components of a computing system 100 shown in FIG. 1B, a computing system 100a shown in FIG. 2, or a computing system 100b also shown in FIG. 2.

The power system 52 includes means for powering some portion of the machine 50, such as the computing system 51 and/or the user interface 54. The power system 52 can include a power supply, such as a battery, a generator, a fuel cell, or a solar cell, or some other type of power supply instead or in addition. The power system 52 can include a power circuit for distributing electrical power throughout the machine 50 where needed. The power system 52 can include a connector and/or connection for connecting to another power system, such as a power system within a building and/or a power system of an electrical utility company.

The chassis 53 includes means for supporting and/or protecting other aspects of the machine 50. As an example, the chassis 53 can include a rack for supporting at least portions of the computing system 51, the power system 52, and/or the user interface 54. As another example, the chassis 53 can include a housing in which at least portions of the computing system 51, the power system 52, and/or the user interface 54 reside.

The user interface 54 can include one or more user interface input components configured to receive and/or produce content (e.g., a signal, data, and/or information) based on some action of a user. That content can be provided to the computing system 51. The user interface 54 can include one or more user interface output components for outputting content. That content can be provided by the computing system 51. The user action can occur by use of the user interface 54.

In at least some embodiments, the user interface 54 includes a mechanical user interface input component, such as an arm, handle or lever located on a side of the chassis 53 similar to an arm, handle, or lever located on a mechanical slot machine. As an example, the mechanical user interface input component can be configured to input a spin request to the computing system 51.

In at least some embodiments, the user interface 54 includes an acceptor, such as a paper money acceptor, a coin acceptor, a token acceptor, a validator, and/or a card reader.

In at least some embodiments, the computing system 51 includes at least a portion of the user interface 54. As an example, in embodiments in which the computing system 51 is arranged like the computing system 100, the computing system 100a, or the computing system 100b, the user interface 54 can be arranged like the user interface 104, the user interface 104a, or the user interface 104b, respectively.

Next, FIG. 1B is a block diagram of a computing system 100, in accordance with the example embodiments. The computing system 100 can be arranged as and/or include a stand-alone computing system, a distributed computing system, a personal computer, a server computing system, a client computing system, a portable computing system, a mobile phone, a smartphone, a tablet device, or some other computing device. The computing system 100 can be referred to as a user device.

The computing system 100 can include a communication interface 102, a user interface 104, and a logic module 106, two or more which can be coupled together by a system bus, network, or other connection mechanism 108. The communication interface 102 can include a wired or wireless network communication interface. For purposes of this description, any data described as being provided, sent, or transmitted by the computing system 100 can be data sent by the communication interface 102 over a communication network. In addition, for purposes of this description, any data described as being received by the computing system 100 can be data sent to communication interface 102 over a communication network.

The user interface 104 includes components that can facilitate interaction with a user of the computing system 100. For example, the user interface 104 can include user interface output components, such as a display 110 and/or a speaker 111. As another example, the user interface can include user interface input components, such as an acceptor 107, a user-selectable control 109 (e.g., a keypad, a keyboard, or a mouse), or a touch-sensitive screen. The touch-sensitive screen can be part of the display 110, such that the display 110 is operable as both a user interface input component and a user interface output component. The user-selectable control 109 can include one or more user-selectable controls, one or more of which can be implemented on the touch sensitive screen (which can also be referred to as a touch pad).

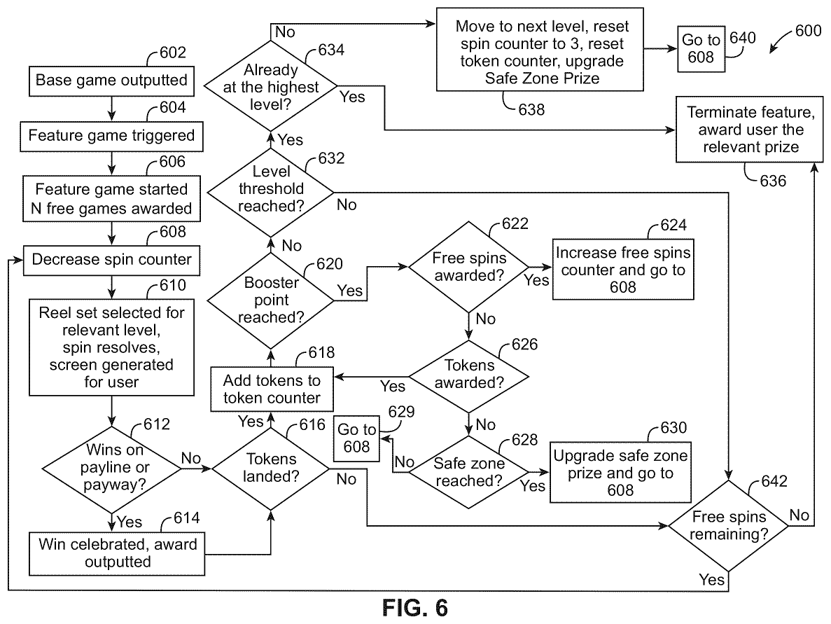

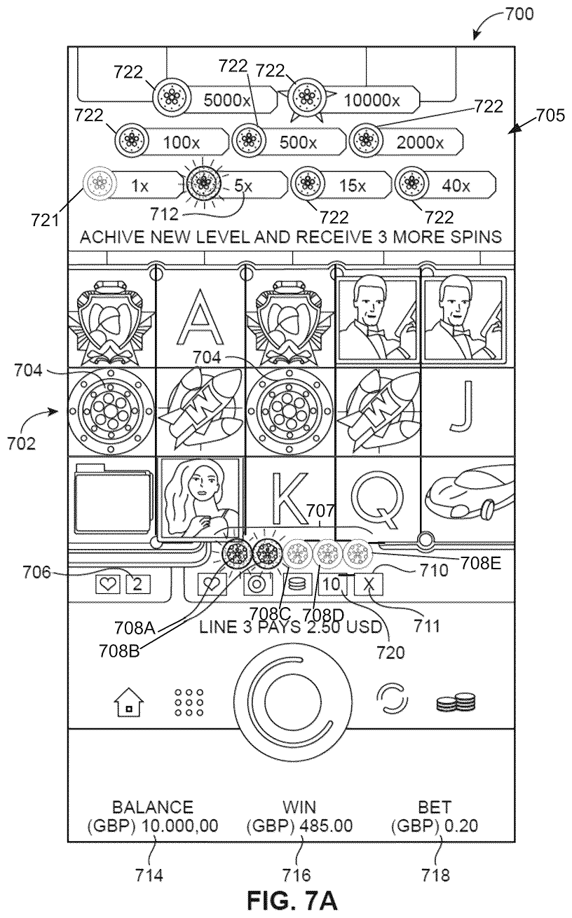

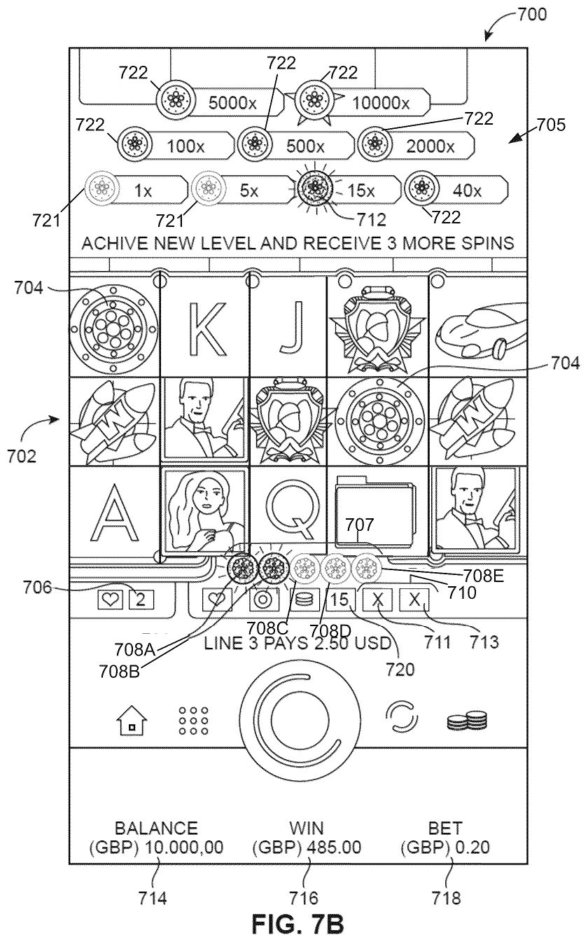

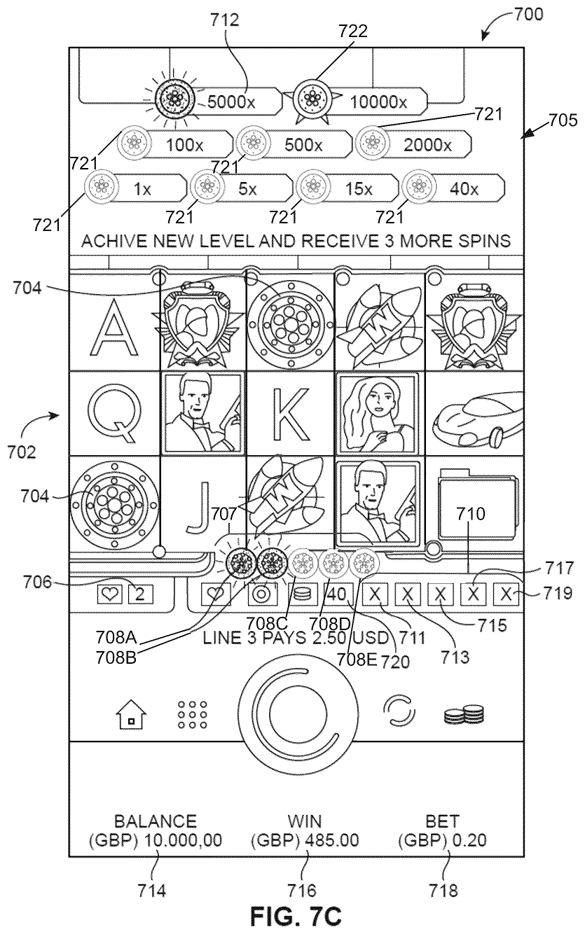

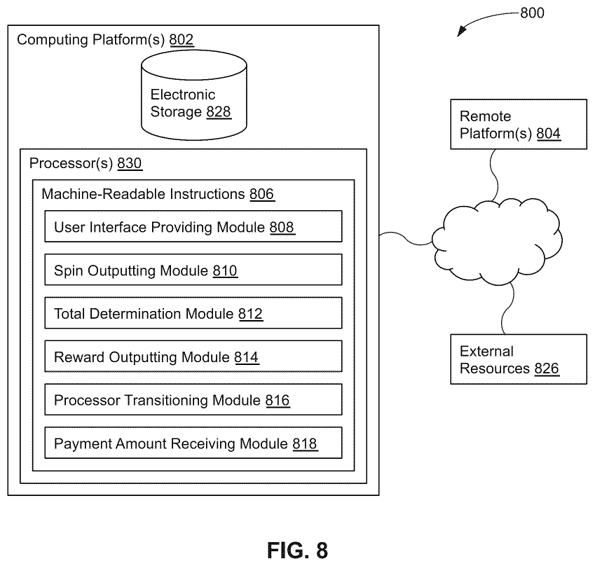

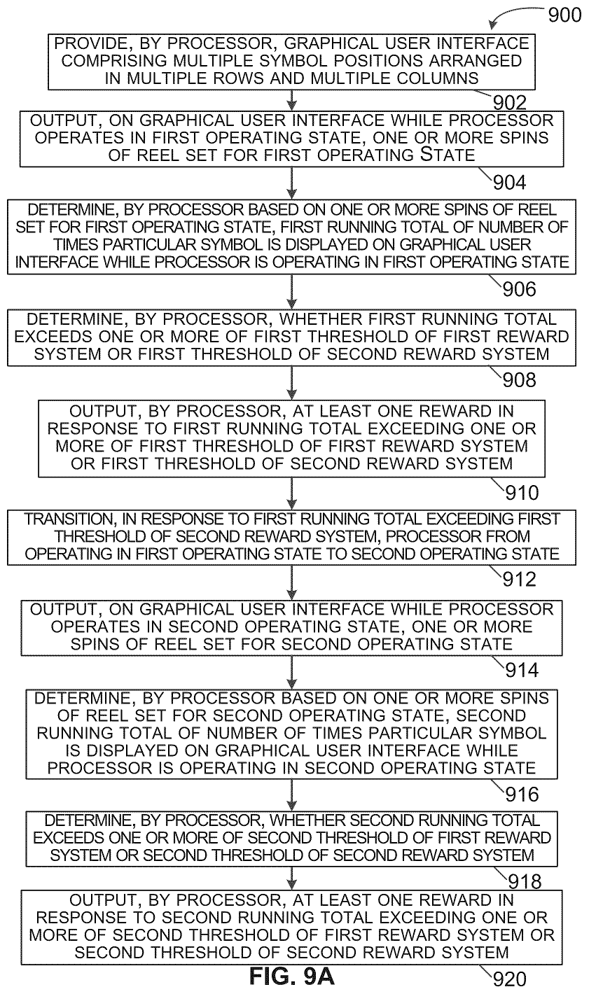

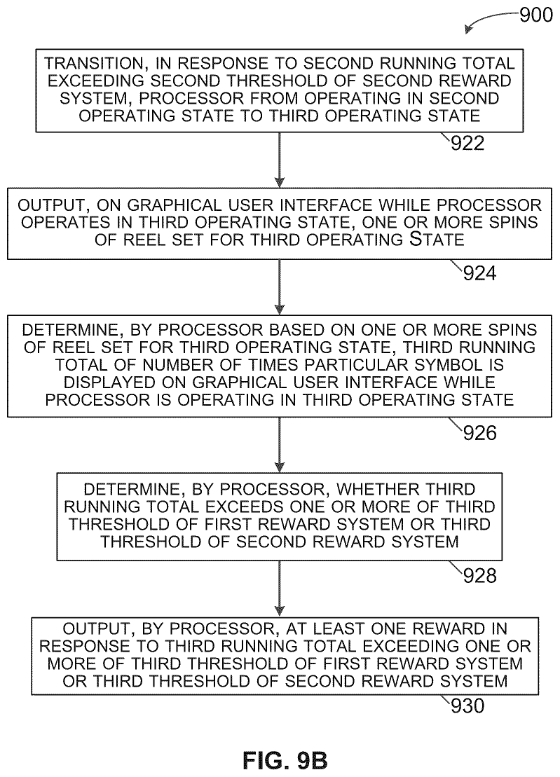

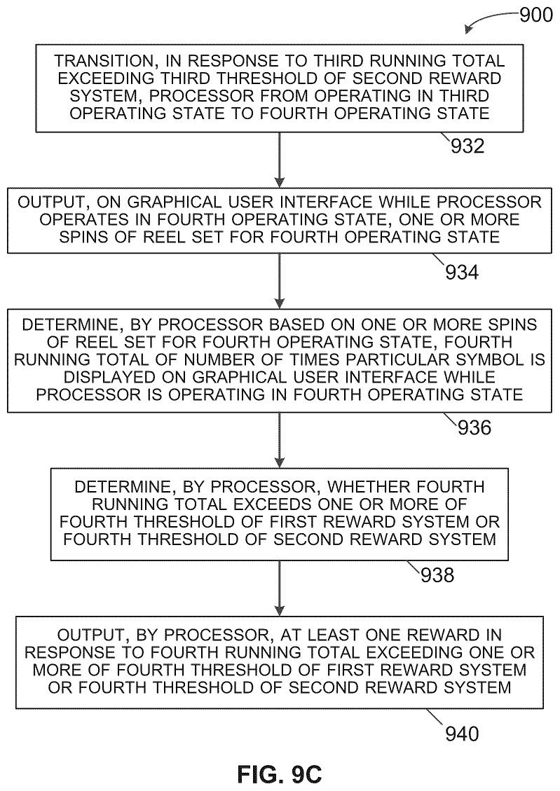

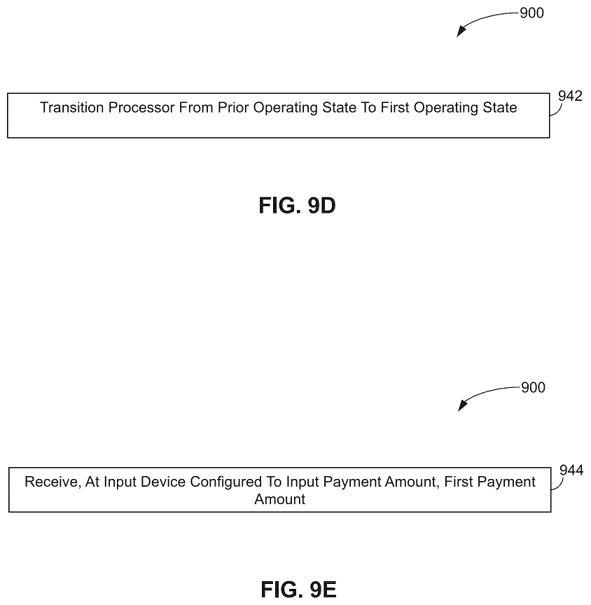

The display 110 is configured to display (i.e., visually present and/or show) content. As an example, the content can correspond to an outcome event, such as a set of symbols selected for the outcome event, a matrix, a reel, a payline, a payway, an award, an instruction, or a user-selectable control (e.g., a button). As another example, the content can include text, a graphic, a GUI, an animation, a video, or some other content as well or instead. As yet another example, the content can include content shown in and/or described with respect to any of FIG. 6, FIG. 7A, FIG. 7B, FIG. 7C, FIG. 8, FIG. 9A, FIG. 9B, FIG. 9C, FIG. 9D and/or FIG. 9E. The display 110 can include a display screen (e.g., a display panel or a graphical display unit) including a quantity of pixels (e.g., 786,432 pixels in an array of pixels that is 1,024 pixels by 768 pixels). Other examples of an array of pixels are possible.

Additionally, the display 110 and/or the display screen can include and/or be arranged as a liquid crystal display (LCD), a light emitting diode (LED) display, an organic LED (OLED) display, a plasma display or some other type of display. Furthermore, the display 110 can embody the touch sensitive screen noted above such that the display 110 and/or display screen includes and/or is arranged as a touch screen display.

The logic module 106 can include and/or be arranged as a processor 112 and/or a memory 114. The processor 112 can include a general-purpose processor (e.g., a microprocessor) or a special-purpose processor (e.g., a graphics process, a digital signal processor or an application specific integrated circuit) and can be integrated in whole or in part with the communication interface 102 or the user interface 104. Any memory discussed in this description or shown in the drawings can be referred to as a computer-readable memory, data storage, computer-readable data storage, among other names.

The memory 114 can include volatile or non-volatile storage components and can be integrated in whole or in part with the processor 112. The memory 114 can take the form of a non-transitory computer-readable medium and can include software program instructions, that when executed by the processor 112, cause the computing system 100 to perform one or more of the functions described herein. Any software program instructions discussed in this description or shown in the drawings can be referred to as computer-readable program instructions, or more simply, program instructions, or a software application.

As an example, the program instructions can be executable by the processor 112 to perform a method, such as a method including one or more of the functions shown in FIG. 6, FIG. 9A, FIG. 9B, FIG. 9C, FIG. 9D, and/or FIG. 9E.

As another example, the program instructions can be executable by the processor 112 to determine a payment has been received by the user interface 104 (e.g., by the acceptor 107) and thereafter allow an outcome to be output in response to an input entered via the user interface 104.

The memory 114 can also include operating system software on which the computing system 100 can operate. For example, the computing system 100 can operate on a Windows®-based operating system available from the Microsoft® Corporation of Redmond, Wash. Other examples of an operating system are possible.

The memory 114 can include a database. As an example, the memory 114 can include a credit account database containing data related to performing an outcome event by a computing system, as well as adjusting account balances (e.g., quantities of credits) associated with client computing systems. The processor 112 can write data into the database and read data within the database.

FIG. 2 is a block diagram of a computing system 100a connected to a computing system 100b over a communication network 118. A configuration of elements including the computing system 100a and the computing system 100b can be referred to as a server-client based configuration.

The components of the computing system 100a and the computing system 100b are shown with corresponding “a” and “b” reference numerals (i.e., based on the computing system 100). For example, the computing system 100a includes a communication interface 102a, a user interface 104a (which includes an acceptor 107a, a user-selectable control 109a, a display 110a, and/or a speaker 111a), a logic module 106a (which includes a processor 112a and/or a memory 114a), and a communication bus 108a. Likewise, the computing system 100b includes a communication interface 102b, a user interface 104b (which includes an acceptor 107b, a user-selectable control 109b, a display 110b, and/or a speaker 111b), a logic module 106b (which includes a processor 112b and/or a memory 114b), and a communication bus 108b. In at least some embodiments, the acceptor 107a includes a validator, and the acceptor 107b includes a paper money acceptor, a coin acceptor, a validator, and/or a card reader.

The computing system 100a is configured to communicate with the computing system 100b over the communication network 118 (via the communication interface 102a and the communication interface 102b). Likewise, the computing system 100b is configured to communicate with the computing system 100a over the communication network 118. For purposes of this description, any data described as being sent or transmitted by the computing system 100a can include data sent by the communication interface 102a over the communication network 118. Similarly, any data described as being sent or transmitted by the computing system 100b can include data sent by the communication interface 102b over the communication network 118. Furthermore, for purposes of this description, any data described as being received by the computing system 100a can include data the computing system 100a receives from the communication network 118 using communication interface 102a. Similarly, any data described as being received by the computing system 100b can include data the computing system 100b receives from the communication network 118 using the communication interface 102b.

In at least some embodiments, the communication network 118 includes a local area network (LAN), such as a LAN located at least partially within a casino. In accordance with those embodiments, multiple instances of the computing system 100b dispersed throughout the casino can communicate with the computing system 100a. In some cases, the computing system 100a can be located within the casino. In some other cases, the computing system 100a can be located away from the casino.

In another example, the communication network 118 can include a wide-area network (WAN), such as an Internet network or a network of the World Wide Web. In such a configuration, the computing system 100b can communicate with the computing system 100a via a website portal (for a virtual casino) hosted on the computing system 100a. The data described herein as being transmitted by the computing system 100a to the computing system 100b or by the computing system 100b to the computing system 100a can be transmitted as datagrams according to the user datagram protocol (UDP), the transmission control protocol (TCP), or another protocol, and/or a file (e.g., a hypertext transfer protocol file) or some other type of file or communication.

The communication network 118 can include any of a variety of network topologies and network devices. The communication network 118 can include a wireless and/or wired network topology and network devices operable on one or both of those network topologies. As an example, the communication network 118 can include a public switched telephone network, a cable network, a cellular wireless network, a wide area network (WAN), a local area network, an IEEE® 802.11 standard for wireless local area networks (wireless LAN) (which is sometimes referred to as a WI-FI® standard) (e.g., 802.11a, 802.11b, 802.11g, 802.11n, or 802.11p), and/or a network operating according to a BLUETOOTH® standard (e.g., the BLUETOOTH® standard 5.3) developed by the Bluetooth Special Interest Group (SIG) of Kirkland, Washington.

As noted, the computing system 100 can include the acceptor 107. In at least some embodiments, the acceptor 107 includes an acceptor of a physical item associated with a monetary value, such as a paper money acceptor, a coin acceptor, or a card reader. The acceptor 107 can include a validator configured to identify the physical item, and determine whether the physical item is suitable as payment to the computing system 100. A coin acceptor can be configured to accept and identify a coin distributed by a geo-political body or a token generated for an organization other than a geo-political body, such as a casino. A card reader can be configured to read a bank card (e.g., a credit or debit card) or a customer card (e.g., a casino loyalty card).

In at least some embodiments, the computing system 100 can also physically dispense a corresponding award or payout (e.g., cash), or otherwise facilitate the payout (by adding funds to an electronic account associated with a customer card). Such an activity can be triggered by a cash out button either on the display 110 or elsewhere on the computing system 100. Additionally or alternatively to determining the payout amount, the computing system 100 can perform other actions to award the user. For instance, the computing system 100 can display an indication of a tangible prize. Other types of awards can be used as well.

For purposes of this description, a function that can be performed by the computing system 100, the computing system 100a, or the computing system 100b can be performed, at least in part, by a processor of that computing system executing program instructions and/or a software application. Those program instructions and/or software application can be stored within the memory 114, 114a, or 114b, respectively.

The memory 114, 114a, and 114b can also store data. The memory 114, 114a, 114b can include a global symbol group for an outcome event that includes multiple symbols, such as a reel-based outcome event. As an example, the multiple symbols can include a wild symbol, an ace symbol, a king symbol, a queen symbol, a jack symbol, a ten symbol and/or a nine symbol. The ace, king, queen, jack, ten and nine symbols can represent symbols found on a standard deck of playing cards. The wild symbol can have special properties that allow it to form winning combinations with other symbols. In at least some embodiments, an “A” symbol represents the ace symbol, a “K” symbol represents the king symbol, a “Q” symbol represents the queen symbol, a “J” symbol represents the jack symbol, a “10” symbol represents the ten symbol, and a “9” symbol represents the nine symbol. Other examples of symbols within the global symbol group are possible.

In at least some embodiments, the symbol group generally has a “hierarchy”, which can define different values for at least some of the symbols. For example, a winning pattern including three lower-value symbols (e.g., a “9” symbol) will have a lower value than a winning pattern with three higher-value symbols (e.g., a “10” symbol).

However, such a global symbol group can be customized with particular symbols as desired. As some possible examples, the symbols can include images of people, animals, dinosaurs, fanciful creatures, cartoon characters, inanimate objects, or other things in addition to or instead of wild, ace, king, queen, jack, ten or nine symbols. Furthermore, wild symbols can vary in design. The global symbol group can be represented as a table (or other data structure) stored in the memory 114.

A memory can include one or more memories. For example, a memory can include the memory 114. As another example, a memory can include the memory 114a and the memory 114b. In accordance with this latter example, a memory can be arranged as a distributed memory. One or more processors can be operatively coupled to a memory. For example, the processor 112 is operatively coupled to the memory 114. As another example, the processor 112a is operatively coupled to the memory 114a, and the processor 112b is operatively coupled to the memory 114b. In accordance with this latter example, a processor can be arranged as a distributed processor.

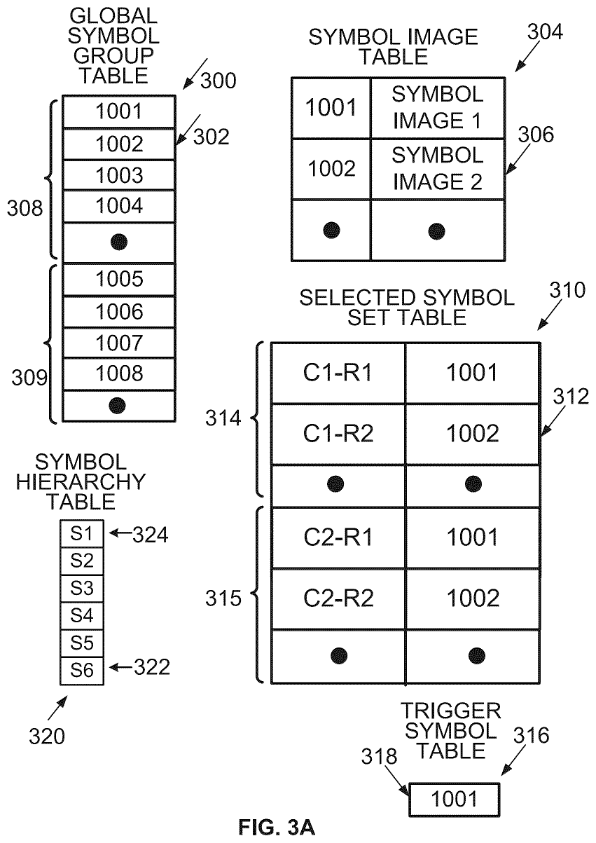

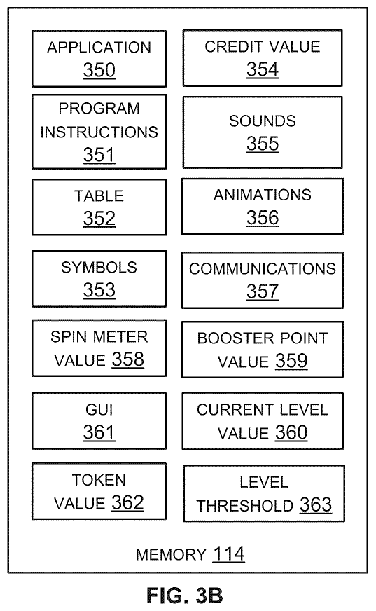

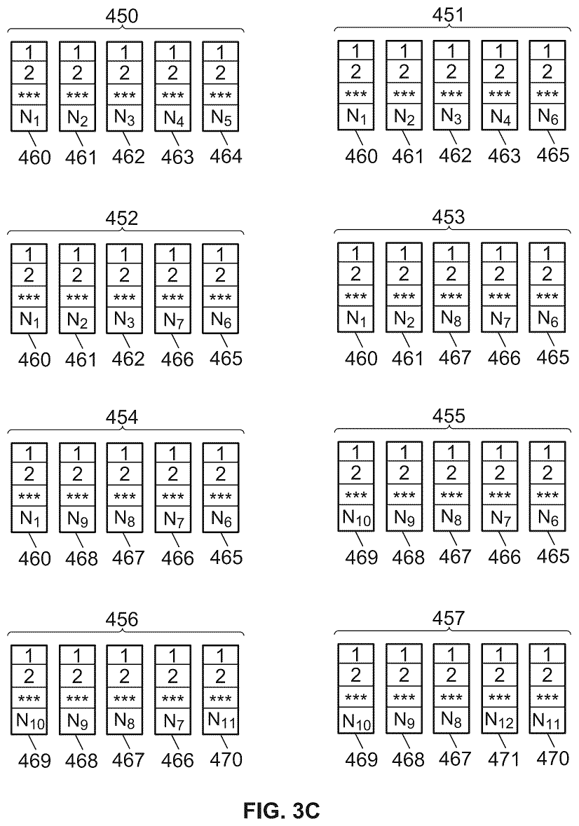

Next, FIG. 3A data that can be stored in a memory (e.g., the memory 114, 114a, 114b), in accordance with the example embodiments. In particular, FIG. 3A shows a global symbol group table 300, in accordance with the example embodiments. The global symbol group table 300 includes multiple records 302, each including an identifier (e.g., 1001, 1002, 1003 1004, etc.) that represents a particular symbol. In one example, the global symbol group, and therefore the global symbol group table 300, can be divided into multiple sub-groups (e.g., a sub-group 308, 309).

The global symbol group table 300 can be used in connection with a symbol image table 304. The symbol image table 304 includes multiple records 306 (shown as distinct rows of the symbol image table 304), each including an identifier that represents a particular symbol, and a corresponding displayable image. As such, the symbol image table 304 can be used to map an identifier in the global symbol group table 300 to a displayable image. Such an image can be arranged according to the Joint Photographic Experts Group (JPEG), Graphics Interchange Format (GIF), or Portable Network Graphics (PNG) encodings, for example. As an example, the image can include a representation of a symbol from a playing card in a typical deck of playing cards, such as a “9” symbol, a “10” symbol, a “J” symbol, a “Q” symbol, a “K” symbol, and an “A” symbols, examples of which are shown in FIG. 5. As another example, the image can include a representation of a person, a rocket ship, a car, and a shield, examples of which are shown in FIG. 7A, FIG. 7B, and/or FIG. 7C. Other examples of symbols in the symbol image table 304 are also possible.

During the course of an event, various symbol sets can be selected for display. Each selected symbol set can be stored in a table such as a selected symbol set table 310. The selected symbol set table 310 includes multiple records 312 (shown as distinct rows in selected symbol set table 310), each record including a symbol position of the symbol, and an identifier that represents the symbol. As such, each symbol in the selected symbol set can correspond to a respective symbol position in a display arrangement (e.g., both a column number and a row number in a column-and-row arrangement). As an example, C1-R1, shown in the selected symbol set table 310, represents a symbol position at column 1 (e.g., a left-most column of multiple columns in a symbol-display-portion of display 110) and row 1 (e.g., a top row of multiple rows in a symbol-display-portion of the display 110). The column identifiers in the selected symbol set table 310 (e.g., C1 and C2) can refer to columns in a symbol matrix or reels of multiple reels that can be spun.

Portions of the multiple records 312 can be grouped into a respective subset of symbol records. As an example, a subset of symbol records can include all the symbol records for a particular column or reel in a matrix. For instance, a subset 314 of symbol records can include all the symbol records for column C1 and/or a corresponding reel, and a subset 315 of symbol records can include all of the symbol records for column C2 and/or a corresponding reel. A person having ordinary skill in the art will understand that the global symbol group table 300 can include more than two subsets of symbol records, and the subsets of symbol records can correspond to an aspect other than a particular column (e.g., a particular row).

In accordance with the example embodiments, the computing system 100 can select a symbol set for outputting on the user interface 104 by iterating through each record 312 in the selected symbol set table 310. As an example, for each symbol position in the selected symbol set table 310 (i.e., each symbol position in the left-most column of the selected symbol set table 310), the processor 112 can determine a symbol identifier from among the symbol identifiers in the global symbol group table 300. In at least some embodiments, the symbol identifiers are numbers and the processor 112 uses a random number generator to determine numbers in the global symbol group table 300 to associate with each symbol position in the selected symbol set table 310. Other examples of how the computing system 100 and/or the processor 112 randomly determine symbols for the selected symbol set table 310 are also possible.

In at least some embodiments, the computing system 100 determines each symbol of the selected symbol set table 310 by randomly selecting any symbol from within the selected symbol set table 310.

In at least some other embodiments, the computing system 100 determines each symbol of the selected symbol set table 310 by randomly selecting each symbol for each subset of symbol records (e.g., the subset 314, 315 of symbol records) from a corresponding sub-group within the global symbol group table 300. For example, the computing system 100 can determine the symbols for the subset 314 of symbol records by randomly selecting symbols from the sub-group 308 and determine the symbols for the subset 315 of symbol records by randomly selecting symbols from the sub-group 309.

In at least some embodiments, the computing system 100 can first determine the symbols within the selected symbol set table 310 from the global symbol group table 300 and then determine a symbol position for each of those symbols. Determining the symbol position for a symbol can include the computing system 100 randomly selecting a symbol position from among multiple remaining, unassigned symbol positions and assigning the selected symbol position to one of the predetermined symbols. As an example, selecting the symbol position for an embodiment in which the display arrangement is a column-and-row arrangement can include the computing system 100 randomly determining a column identifier and a row identifier (from a set of remaining, unassigned column and row identifier combinations) for each of the predetermined symbols until there is only one remaining, unassigned column and row identifier. A last predetermined symbol would then be assigned to correspond to the one remaining, unassigned column and row identifier. As another example, selecting the symbol position for an embodiment in which the display arrangement is specified using symbol position identifiers (e.g., whole number 1 through 15, inclusive) can include the computing system 100 randomly determining a symbol position identifier (from a set of remaining, unassigned symbol position identifiers) for each of the predetermined symbols until there is only one remaining, unassigned symbol position identifier. A last predetermined symbol would then be assigned to correspond to the one remaining, unassigned symbol position identifier.

In accordance with embodiment in which a column and row arrangement is used to simulate reels, the computing system 100 can display each subset of selected symbols in a corresponding column. As an example, the computing system 100 can superimpose each subset of selected symbols over a virtual reel in a corresponding column. Thus, a sub-group 308, 309 can represent an ordering of symbols on a particular reel.

As another example, the memory can contain a symbol hierarchy table 320. The symbol hierarchy table 320 can include an ordered list of symbols. The ordered list of symbols can include at least a portion of the symbols within global symbol group table 300. As shown in FIG. 3A, the symbol hierarchy table 320 includes a symbol S1, S2, S3, S4, S5, S6 arranged in an order from a first symbol 322 (i.e., symbol S6) to a final symbol 324 (i.e., symbol S1). A person having ordinary skill in the art will understand that the symbol hierarchy table 320 includes a different quantity of symbols. In accordance with at least some implementations, symbol S6 can be a “9” symbol, symbol S5 can be a “10” symbol, symbol S4 can be a “J” symbol, symbol S3 can be a “Q” symbol, symbol S2 can be a “K” symbol, and symbol S1 can be an “A” symbol.

Next, FIG. 3B shows the memory 114 and data that can be stored in the memory, in accordance with the example embodiments. The memory 114a can contain at least some of the data stored in the memory 114. Likewise, the memory 114b can contain at least some of the data stored in the memory 114. In at least some embodiments, at least a portion of the memory 114 is embodied as a data register within the processor 112.

As shown in FIG. 3B, the memory 114 can include one or more from among: an application 350, program instructions 351, a table 352, symbols 353, a credit value 354, sounds 355, animations 356, communications 357, a spin meter value 358, a booster point value 359, a current level value 360, a GUI 361, a token value 362, or a level threshold 363.

The application 350 can include any software application discussed in this description. The application 350 can also include an operating system, such as any operating system described in this description.

The program instructions 351 are computer-readable program instructions (e.g., machine-readable instructions) executable by one or more processors. The program instructions 351 can be executable to cause a computing system or a component of the computing system to perform any function described in this description. The program instructions 351 can include the application 350. The program instructions 351 can include one or modules. As an example, the modules of the program instructions 351 can include one or more from among a user interface providing module 808, a spin outputting module 810, a total determination module 812, a reward outputting module 814, a processor transitioning module 816, or a payment amount receiving module 818. Each of those modules is shown in FIG. 8.

The table 352 can include one or more tables, such as one or more tables shown in FIG. 3A. In at least some embodiments, the memory 114 can contain any data described as being stored in a table in some manner other than a table. As an example, the memory 114 can store program instructions that include data described as being contained in a table.

The symbols 353 can include computer-readable data a processor can read to generate a symbol on a display screen, graphical display unit, graphical display interface, or GUI. As an example, the symbols 353 can include a respective computer-readable file (e.g., a bitmap file) for each symbol. As another example, the symbols 353 can include a computer-readable file a processor can read to generate any symbol discussed in this description and/or shown in the drawings, such as a “9” symbol, a “10” symbol, a “J” symbol, a “Q” symbol, a “K” symbol, or an “A” symbol. A table, such as the symbol image table 304, can include an index value (e.g., a numerical identifier or a file name) corresponding to a symbol in the symbols 353.

The credit value 354 can indicate a number of credits available for a user of a computing system. The number of credits can be referred to as a credit value. If the credit value 354 is stored in the memory 114b, the credits can include a number of credits available for a user of the computing system 100b. If the credit value 354 the stored in the memory 114a, the credits can include a respective number of credits available for a user of a respective computing system arranged like the computing system 100b. A processor can update the credits available for each user based on payments entered at a computing system by that user, awards earned by use of the computing system by that user, and/or by use of an acceptor and/or validator. The credit value and/or the token value can be output on the display 110, 110a, 110b. As an example, for an implementation in which a GUI 700 (shown in FIG. 7A, FIG. 7B, and/or FIG. 7C) is output on the display 110, 110a, 110b, the credit value 354 can be displayed with a credit meter 714 (shown in FIG. 7 A, FIG. 7B, and/or FIG. 7C).

The sounds 355 include audio files (e.g., an audio clip) that the processor 112 can output to a speaker. Outputting an audio file can include outputting a signal that produces a particular sound when the signal passes through a speaker. As an example, the particular sound can include a first particular sound to play when reels are spinning on the display 110b or a second particular sound to play when symbols are being upgraded between outcome events. As another example, the particular sound can include a particular sound played for first, second, third, or fourth operating states discussed below with respect to FIG. 13. As another example, the sounds 355 can include an audio file, such as an audio file with one of the following file name extensions: WAV, MP3, MP4, WMA, or some other file name extension.

Each sound in the sounds 355 can correspond to an index value such that the processor 112a can provide the processor 112b with an instruction including a particular index value so that the processor 112b outputs via the speaker 111b an audio file corresponding to the particular index value. Accordingly, the processor 112a does not have to transmit the audio file to the processor 112b each time the audio file is to be output via the speaker 111b.

The animations 356 can include computer-readable files containing animations on a display, such as the display 110, 110a, 110b. As an example, the animations 356 can include animation files, such as an animation file with one of the following file name extensions: GIF, PNG, JPEG, SVG, or some other file name extension. Each animation in the animation 356 can correspond to an index value such that the processor 112a can provide the processor 112b with an instruction including a particular index value so that the processor 112b outputs via the display 110b an animation file corresponding to the particular index value. Accordingly, the processor 112a does not have to transmit the animation file to the processor 112b each time the animation file is to be output via the display 110b.

In at least some embodiment, an animation of the animations 356 is an entire graphical display output on display 110, 110a, 110b. In at least some other embodiments, an animation of the animations 356 is a portion of a graphical display output on display 110, 110a, 110b. Moreover, in at least some of those latter embodiments, multiple animations of the animations 356 are respective portions of a graphical display output on display 110, 110a, 110b.

The communications 357 include one or more communications, such as one or more from among: a communication sent by the processor 112 coupled to the memory 114, a communication generated for transmitting by the processor 112 coupled to the memory 114, or a communication received by the computing system 100. As an example, for embodiment in which the communications 357 are stored in the memory 114a, the communications 357 can include a communication sent by the processor 112a to the computing system 100b, a communication generated for transmitting by the processor 112a coupled to the computing system 100b, or a communication received by the computing system 100a. As another example, for embodiment in which the communications 357 are stored in the memory 114b, the communications 357 can include a communication sent by the processor 112b to the computing system 100a, a communication generated for transmitting by the processor 112b coupled to the computing system 100b, or a communication received by the computing system 100b.

The spin meter value 358 can include a value that indicates how many additional spins the computing system 100, 100a, 100b can carry out for a particular event, such as a feature event referenced in a block 604 in FIG. 6. The spin meter value 358 can function as a counter that the processor 112, 112a, 112b increments and decrements in response to determining certain events occur. For example, the processor 112, 112a, 112b can increment the spin meter value 358 by a predetermined number of spins or set the spin meter value 358 to a predetermined number in response to the computing system 100, 100a, 100b changing levels in the feature event and/or changing operating states as a resulting of changing to a different level in the feature event. As an example, for an implementation in which the GUI 700 (shown in FIG. 7A, FIG. 7B, and/or FIG. 7C) is output on the display 110, 110a, 110b, the spin meter value 358 can be displayed with a spin meter 706 (shown in FIG. 7A, FIG. 7B, and/or FIG. 7C) or a spin meter shown within some other display screen.

The booster point value 359 can include a value that indicates how many tokens (e.g., instances of a particular or special symbol) need to be collected to reach a next booster point. The “Tokens Collected” column and rows identifying a booster point in Table A show examples of the booster point value 359. As an example, for an implementation in which the GUI 700 (shown in FIG. 7A, FIG. 7B, and/or FIG. 7C) is output on the display 110, 110a, 110b, the value of the booster point value 359 can be displayed with a booster point meter 710 (shown in FIG. 7A, FIG. 7B, and/or FIG. 7C).

The current level value 360 can include a value that indicates a particular multiplier value that has been selected by the processor 112, 112a, 112b for a particular operating state of the computing system 100, 100a, 100b. The particular operating state can correspond to a particular level of a reward system. The particular multiplier value can be selected from a predetermined, ordered list of multiplier values. As an example, for an implementation in which the GUI 700 (shown in FIG. 7A, FIG. 7B, and/or FIG. 7C) is output on the display 110, 110a, 110b, the current level value 360 can be displayed with a current level display 705 (shown in FIG. 7A, FIG. 7B, and/or FIG. 7C). In accordance with that implementation, the ordered list of multiplier values includes the following multiplier values: 1×, 5×, 15×, 40×, 100×, 500×, 2,000×, 5,000×, and 10,000×. Different examples of an ordered list of multiplier values is possible.

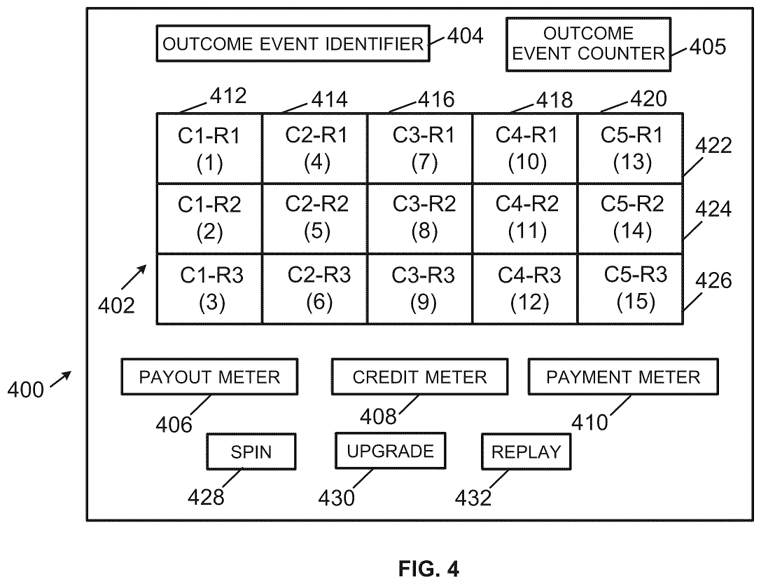

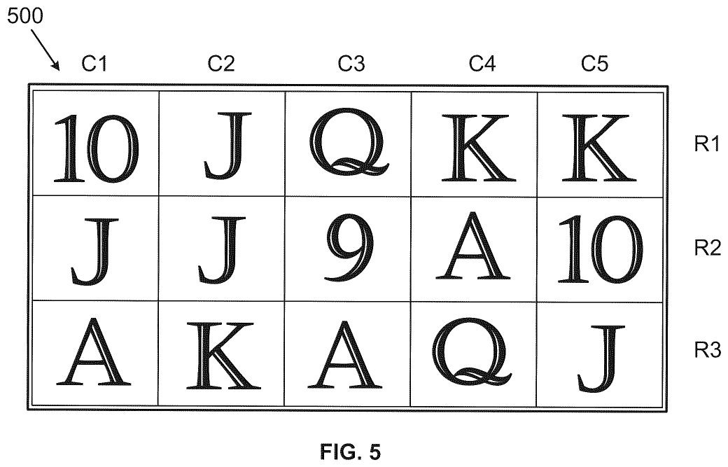

The GUI 361 can include one or more graphical user interfaces. A GUI with the GUI 361 can include a static GUI that includes content that does not change. Additionally or alternatively, a GUI within the GUI 361 can include a dynamic GUI with one or more aspects that are configured to change while the GUI is output on the display 110, 110a, 110b. As an example, a changeable aspect of a GUI can include an aspect in which an animation of the animations 356 is displayed. In particular, for example, the aspect can include a symbol display portion in which an animation of a selected reel set is spun and stopped during a feature event described herein. As another example, a GUI within the GUI 361 can include one or more meters, such as one or more meters discussed with respect to a GUI 400 shown in FIG. 4 or a GUI 700 shown in FIG. 7A, FIG. 7B, and/or FIG. 7C.

The token value 362 can indicate a number of tokens earned during an event performed by the computing system 100, 100a, 100b. The token value 362 can be reset to a predetermined value (e.g., zero) in response to the processor 112, 112a, 112b changing operating states and levels of a feature event, and/or upon reaching a next booster point.

The level threshold 363 can include data indicating how many tokens (e.g., instances of a particular or special symbol appearing on a GUI) need to be collected to complete a current level of a multi-level feature event. As an example and with reference to Table A below, for a feature event having eight levels numbered zero to seven, the level threshold 363 can include the following data: (Level 0, five tokens), (Level 1, ten tokens), (Level 2, fifteen tokens), (Level 3, twenty tokens), (Level 4, twenty-five tokens), (Level 5, thirty tokens), (Level 6, thirty-five tokens), (Level 7, forty tokens). The level threshold 363 can indicate that one of those levels and token quantities is the current level and token quantity in use by the feature event.

Next, FIG. 3C shows multiple sets of reels in accordance with the example embodiments. In particular, FIG. 3C shows a reel set 450, 451, 452, 453, 454, 455, 456, 457. The reel set 450, 451, 452, 453, 454, 455, 456, 457 can correspond to a reel set A, B, C, D, E, F, G, H, respectively, shown in Table A below. Each reel set 450, 451, 452, 453, 454, 455, 456, 457 is shown to include five reels. In other embodiments, a reel set can have a different number of reels.

The reel set 450 includes a reel 460, 461, 462, 463, 464 having a quantity of N₁, N₂, N₃, N₄, N₅ symbols, respectively. Two or more quantities of symbols shown in FIG. 3C in the form of N_{X}, where X is an integer, can be identical quantities. Additionally or alternatively, two or more quantities of symbols shown in FIG. 3C in the form of N_{X}, where X is an integer, can be different quantities. As an example, each quantity in the form of N_{X} in FIG. 3C can be a quantity within the range of 30 and 256, inclusive. Other example of a range of the quantities in the form of N_{X} in FIG. 3C are also possible. The characters “1” and “2” in FIG. 3C represent two symbol positions in each reel. The characters “***” in FIG. 3C represent a number of symbol positions between symbol position “2” and the symbol position listed in the form of N_{X}.

The reel set 451 includes a reel 460, 461, 462, 463, 465 having a quantity of N₁, N₂, N₃, N₄, N₆ symbols, respectively. In other words, four left-most reels shown in the reel set 450 and the reel set 451 are identical and the right-most reels shown in the reel set 450 and the reel set 451 are different.

The reel set 452 includes a reel 460, 461, 462, 466, 465 having a quantity of N₁, N₂, N₃, N₇, N₆ symbols, respectively. The difference between the reel set 452 and the reel set 451 is the inclusion therein of the reel 464 and the reel 465, respectively.

The reel set 453 includes a reel 460, 461, 467, 466, 465 having a quantity of N₁, N₂, N₈, N₇, N₆ symbols, respectively. The difference between the reel set 452 and the reel set 453 is the inclusion therein of the reel 462 and the reel 467, respectively.

The reel set 454 includes a reel 460, 468, 467, 466, 465 having a quantity of N₁, N₉, N₈, N₇, N₆ symbols, respectively. The difference between the reel set 454 and the reel set 453 is the inclusion therein of the reel 461 and the reel 468, respectively.

The reel set 455 includes a reel 469, 468, 467, 466, 465 having a quantity of N₁₀, N₉, N₈, N₇, N₆ symbols, respectively. The difference between the reel set 455 and the reel set 454 is the inclusion therein of the reel 460 and the reel 469, respectively.

The reel set 456 includes a reel 469, 468, 467, 466, 470 having a quantity of N₁₀, N₉, N₈, N₇, N₁₁ symbols, respectively. The difference between the reel set 456 and the reel set 455 is the inclusion therein of the reel 465 and the reel 470, respectively.

The reel set 457 includes a reel 469, 468, 467, 471, 470 having a quantity of N₁₀, N₉, N₈, N₁₂, N₁₁ symbols, respectively. The difference between the reel set 457 and the reel set 456 is the inclusion therein of the reel 466 and the reel 471, respectively.

In at least some embodiments, the reels within the reel set 450, 451, 452, 453, 454, 455, 456, 457 includes symbols within the symbol image table 304.

In at least some embodiments, the selected symbol set table 310 can include multiple selected symbol set tables, each multiple selected symbol set table corresponding to a respective one of the reel set 450, 451, 452, 453, 454, 455, 456, 457. In accordance with those embodiments, the selected symbol set table 310 shown in FIG. 3A can correspond to one of the reel set 450, 451, 452, 453, 454, 455, 456, 457, such as the reel set 450. In accordance with that example, the subset 314 of symbol records and the subset 315 of symbol records can correspond to two reels of the reel set 450, such as the reel 460 and the reel 461, and the selected symbol set table 310 can further include a respective subset of symbol records for each of the reel 462, the reel 463, and the reel 464.

Next, FIG. 4 depicts a GUI 400 that the computing system 100, the computing system 100a, or the computing system 100b can output on the display 110, 110a, and 110b, respectively. For purposes of this description, each element of the GUI 400 can be a displayable element of the GUI 400. The GUI 400 includes a symbol-display-portion 402, an outcome event identifier 404, an outcome event counter 405, a payout meter 406, a credit meter 408, and a payment meter 410.

The symbol-display-portion 402 can include multiple symbol-display-segments and multiple symbol positions. As an example, the symbol-display-segments can include a vertical symbol-display-segment (SDS) 412, 414, 416, 418, 420. As another example, the symbol-display-segments can include a horizontal symbol-display-segment 422, 424, 426. Each symbol-display-segment can include multiple symbol positions. The vertical SDS 412 to the vertical SDS 420 are shown as having three symbol positions. The horizontal SDS 422, 424, 426 are shown as having five symbol positions. A person skilled in the art will understand that those symbol-display-segments can be configured with a different number of symbol positions.

In at least some embodiments, the vertical SDS 412, 414, 416, 418, 420 is configured as a spinnable reel. The GUI 400 can display the spinnable reels spinning by displaying an animation of the reels spinning and the displaying reels coming to a stop. For vertical SDS 412, 414, 416, 418, 420, the spinnable reels can spin in a vertical direction (e.g., top to bottom or bottom to top, with respect to the symbol-display-portion 402).

In at least some other embodiments, the horizontal SDS 422, 424, 426 is configured as a spinnable reel. The GUI 400 can display the spinnable reels spinning and stopped after spinning. For the horizontal SDS 422, 424, 426, the spinnable reels can spin in a horizontal direction (e.g., left to right or right to left, with respect to the symbol-display-portion 402).

The computing system 100 can cause a symbol-display-segment to spin, and to cause a spinning symbol-display-segment to stop spinning. The spinning and stopping of the spinning symbol-display-segment can be carried out for each outcome event. In accordance with the embodiments in which the symbol-display-portion 402 includes columns or reels that spin from top to bottom or bottom to top, spinning the reels can include starting the spinning from a left-most column or reel to a right-most column or reel. Stopping the reels can occur using a similar sequence. Other sequences of spinning and stopping the spinning can be used. Moreover, the spinning or stopping of spinning of two or more columns or reels can occur simultaneously.

The multiple symbol positions in the symbol-display-portion 402 are identified by column and row designators, in which C1=column 1, C2=column 2, C3=column 3, C4=column 4, C5=column 5, R1=row 1, R2=row 2, and R3=row 3. The multiple symbol positions in the symbol-display-portion 402 are also identified by distinct numerical identifiers shown within parenthesis. C1 can be a first SDS. C2 can be a second SDS. C3 can be a third SDS. C4 can be a fourth SDS. C5 can be a fifth SDS. As shown in FIG. 4, C2 is between C1 and C3, C3 is between C2 and C4, and C4 is between C3 and C5.

For a matrix arrangement with 15 symbol positions as shown in FIG. 4, the numerical identifiers can be whole numbers 1 through 15, inclusive. The processors or computing systems described herein can be configured to select a symbol position of the symbol-display-portion 402 using a random number generator that is configured to generate a number within the range 1 through N, inclusive, where N equals the number of symbol positions in the symbol-display-portion 402. For the matrix arrangement, each symbol-display-segment can be a distinct column of the multiple columns within the matrix. Alternatively, for the matrix arrangement, each symbol-display-segment can be a distinct row of the multiple rows within the matrix.

The processor of a computing system described herein can determine an operating state of the computing system and/or an outcome event that can occur during the determined operating state. In response to making those determination(s), the processor can cause the outcome event identifier 404 to display an identifier of the outcome event that can occur during the determined state. For example, the outcome event identifier can identify a base outcome event, a bonus outcome event or another type of outcome event. The bonus outcome event can be a “free spins” outcome event or some other outcome event.

The processor of a computing system described herein can determine a payment amount placed on an outcome event, an award or payout amount after or during occurrence of an outcome event resulting in a win, a credit balance after or while decreasing a number of credits based on a payment or after or while increasing a number of credits based on a determined award or payout amount, and/or a number of awarded remaining outcome events that can occur. The processor can cause the determined payment amount to be displayed by the payment meter 410, the determined payout amount to be displayed by the payout meter 406, the determined credit balance to be displayed by the credit meter 408, and the number of awarded remaining outcome events to be displayed by the outcome event counter 405.

In at least some embodiments, a memory (e.g., the memory 114, 114a, 114b) can include a payout table. Moreover, in at least some of those embodiments, a processor (e.g., the processor 112, 112a, 112b) can read at least a portion of the payout table within the memory, in at least some embodiments, the processor can output at least a portion of the table on a user interface (e.g., the user interface 104, 104a, 104b). The payout table can indicate various sets or combinations of symbols that are defined as a winning outcome and an award or payout corresponding to each winning outcome. A symbol in those sets or combinations can include a regular symbol or a wild symbol. A regular symbol represents only a single symbol. In contrast, a wild symbol can represent one or more regular symbols depending on what regular symbol is needed for a particular payline or payway including the wild symbol to result in a winning outcome and how many paylines or payways are evaluated by the processor.

As an example, a winning outcome can include three instances of the same regular symbol (or a combination of the same regular symbol and one or more wild symbols in three symbol positions) along a given payline or payway. As another example, a winning outcome can include four instances of the same regular symbol (or a combination of the same regular symbol and one or more wild symbols in four symbol positions) along a given payline or payway As yet another example, a winning outcome can include five instances of the same regular symbol (or a combination of the same regular symbol and one or more wild symbols in five symbol positions) on a given payline or payway. As yet another example, an award corresponding to one or more of the aforementioned winning outcomes can include an award of one or more credits added to a credit meter balance contained in a memory for a user using the computing system 100b. Other examples of a winning combination and a corresponding award within the payout table are possible.

The GUI 400 can include one or more user-selectable controls (USCs). As shown in FIG. 4, the GUI 400 can include a USC 428, 430, 432. Selection of the USC 428, 430, 432 can cause the processor 112b and/or another component of the computing system 100b to perform one or more functions. As an example, selection of the USC 428 can cause the processor 112b to transmit a spin request and/or a communication including a spin request (e.g., a communication Com-3 shown in Table A below). As another example, selection of the USC 430 can cause the processor 112b to upgrade a symbol shown on the display and/or to transmit a communication including an upgrade request (e.g., a communication Com-4 shown in Table A below). As yet another example, selection of the USC 432 can cause the processor 112b to replay an outcome event via the user interface 104b.

In at least some embodiments, a USC on a GUI can be reconfigured depending on an operating state of the computing system 100, the computing system 100a, or the computing system 100b. As an example, a single USC on the GUI 400 can be configured as the USC 428 when the computing system 100b is operating in an operating state in which the computing system 100b is not performing an outcome event for the computing system 100b, and as the USC 430 when the computing system 100b is operating in an operating state in which the computing system 100b is performing an outcome event for the computing system 100b. In at least some of those embodiments, the single USC may be unelectable while the computing system 100b is performing a outcome event for the computing system 100b until the processor determines the outcome event includes a winning combination on a payline or payway.

Next, FIG. 5 shows a selected symbol set 500, in accordance with the example embodiments. The selected symbol set 500 can include symbols selected from the global symbol group table 300 for display during an outcome event. The symbols shown in FIG. 5 are arranged according to the symbol-display-portion 402. In particular, the selected symbol set 500 includes: (i) a “10” symbol at a symbol position C1-R1 and a symbol position C5-R2, (ii) a “J” symbol at a symbol position C2-R1, a symbol position C1-R2, a symbol position C2-R2, and a symbol position C5-R3, (iii) a “Q” symbol at a symbol position C3-R1, a symbol position C3-R2, and a symbol position C4-R3, (iv) a “K” symbol at a symbol position C4-R1, a symbol position C5-R1, and a symbol position C2-R3, and (v) an “A” symbol at a symbol position C4-R2, a symbol position C1-R3, and a symbol position C3-R3. Other arrangements of symbols, in terms of the number of columns, number of rows, or the layout of symbols, are possible. III. EXAMPLE OPERATION

In some existing reel-based slot events having bonus rounds, special symbols may be collected where a user may be awarded a prize based on the number of special symbols collected. For example, a first threshold number of symbols may offer a small jackpot prize, a higher threshold number may offer a medium, higher jackpot prize, and the maximum number of symbols may award a maximum jackpot prize. Such existing reel-based slot events, however, generally fail to increase difficulty, anticipation, and, thus, entertainment in successive bonus rounds within a single event.

Implementations described herein address the aforementioned shortcomings and other shortcomings by providing multi-level progression for a software-based reel event. For example, some embodiments provide a reel-based slot event with a first reward system and a second reward system that operate concurrently. The second reward system provides intervals occurring between levels of the first reward system. As an event progresses through the levels of the first reward system, a number of sub-intervals can increase in each interval of the second reward system, thus increasing challenge in advancing in the event. In addition, different reel sets can be used in different levels of the first reward system and/or intervals of the second reward system, which can add unpredictability, variance, and, thus, enjoyment to performing events on the computing system. Moreover, a computing system executing the software operates with new machine states and outputs graphical displays contingent upon the new machine states. The graphical displays prompt a user to interact with the computing system so that the computing system functions properly and expeditiously to allow for an increased amount of performing events on the computing system.

Example embodiments of the present disclosure describe a bonus round to a slot event wherein a computing system provides a dual reward, or dual levelling, system. A first reward system (levelling system) can involve multiple levels that the computing system can reach during the bonus round. The computing system can start at a lowest level, with a higher level being reached once a predetermined number of special symbols land during performance of events on the computing system. Each level can have a prize associated therewith. At the end of the bonus round, the computing system can output the prize associated with the current level. The prizes linked to the particular level can be considered a primary reward. The goal of the bonus event can be to reach as high a level as possible, or to achieve the highest level, in order to win the biggest possible prize.

The second reward system (levelling system) can operate at the same time as the first reward system. In other words, the second reward system can include one or more booster levels nested within a sequence of levels of the first reward system. For example, between levels of the first reward system, there can be “booster points” (or, booster positions) where the computing system provides an additional, secondary reward. The secondary reward can cause the computing system to output additional events that are not known in the prior art. The additional events and/or additional level of rewards can arise from new, different operating states of the computing system.

The booster positions can be defined by respective quantities of special symbols that the computing system can output. In at least some embodiments, the booster positions are at predetermined sub-intervals between different levels of the first reward system. A secondary reward can be randomly chosen (and/or modified) from a predetermined list of available secondary rewards.

In an example embodiment, a reel-based slot event is provided. The slot event can include a display including columns and reels, showing a matrix configuration on the display. The columns can represent reels of a slot machine and can be animated to spin and simulate a mechanical slot machine.

In as least some embodiments, a base event is provided, and a bonus round can be triggered during the base event. The trigger can be, for example, the landing of multiple special symbols (e.g., three special symbols), which function as scatter symbols. Irrespective of the positions of the scatter symbols on the display, the user will enter the bonus round if three such symbols land on the display. Other examples of a trigger that leads to a bonus round are possible.

The bonus round can then proceed according to machine instructions and/or data stored within a computer-readable memory. The machine instructions and/or data can include instructions or data described with reference to TABLE A, as follows:

TABLE A
Level Information

| | | | | Safe Zone | |
|---|---|---|---|---|---|
| | Threshold And | Tokens | | Price (Times | Reel |
| Level | Booster Points | Collected | Notes: | User's Wager) | Set |
| 0 | N/A | <5 | | 1 | A |
| | Level Threshold | 5 | The bonus event now moves to level 1 | | |
| 1 | | <5 | | 5 | B |
| | Booster Point 1.1 | 5 | | 8 | |
| | Level Threshold | 10 | The bonus event now moves to level 2 | | |
| 2 | | <5 | | 15 | C |
| | Booster Point 2.1 | 5 | | 25 | |
| | Booster Point 2.2 | 10 | | 30 | |
| | Level Threshold | 15 | The bonus event now moves to level 3 | | |
| 3 | | <5 | | 40 | D |
| | Booster Point 3.1 | 5 | | 50 | |
| | Booster Point 3.2 | 10 | | 60 | |
| | Booster Point 3.3 | 15 | | 80 | |
| | Level Threshold | 20 | The bonus event now moves to level 4 | | |
| 4 | | <5 | | 100 | E |
| | Booster Point 4.1 | 5 | | 150 | |
| | Booster Point 4.2 | 10 | | 170 | |
| | Booster Point 4.3 | 15 | | 190 | |
| | Booster Point 4.4 | 20 | | 210 | |
| | Level Threshold | 25 | The bonus event now moves to level 5 | | |
| 5 | | <5 | | 500 | F |
| | Booster Point 5.1 | 5 | | 550 | |
| | Booster Point 5.2 | 10 | | 600 | |
| | Booster Point 5.3 | 15 | | 650 | |
| | Booster Point 5.4 | 20 | | 700 | |
| | Booster Point 5.5 | 25 | | 750 | |
| | Level Threshold | 30 | The bonus event now moves to level 6 | | |
| 6 | | <5 | | 1000 | G |
| | Booster Point 6.1 | 5 | | 1700 | |
| | Booster Point 6.2 | 10 | | 1800 | |
| | Booster Point 6.3 | 15 | | 1900 | |
| | Booster Point 6.4 | 20 | | 2000 | |
| | Booster Point 6.5 | 25 | | 2100 | |
| | Booster Point 6.6 | 30 | | 2200 | |
| | Level Threshold | 35 | The bonus event now moves to level 7 | | |
| 7 | | <5 | | 5000 | H |
| | Booster Point 7.1 | 5 | | 6000 | |
| | Booster Point 7.2 | 10 | | 6200 | |
| | Booster Point 7.3 | 15 | | 6400 | |
| | Booster Point 7.4 | 20 | | 6600 | |
| | Booster Point 7.5 | 25 | | 6800 | |
| | Booster Point 7.6 | 30 | | 7000 | |
| | Booster Point 7.7 | 35 | | 7200 | |
| | Level Threshold | 40 | The bonus event now terminates | 10000 | |

The bonus round can start at a level 0. The computing system can award three free spins (e.g., free spins of a set of reels). However, other numbers of free spins can be awarded according to different embodiments. During each of the free spins, special symbols, or “tokens” can land on the display. Each token that lands on the display can be counted by the computing system. A value of the count can be stored within a token counter (e.g., the token value 362) stored in the computer-readable memory. The value contained in the token counter (e.g., the token value 362) can be output on the display (e.g., within a token meter 707 shown in FIG. 7A, FIG. 7B, and/or FIG. 7C). If the user runs out of free spins (e.g., the processor 112, 112a, 112b decrements the spin meter value 358 to zero) without having collected at least five tokens, the bonus round (e.g., the feature event) can end. The processor 112, 112a, 112b can then output an award equal to 1 times their wager, i.e., the same as their wager, as illustrated in the column with “Safe Zone Prize”. This column indicates that when the bonus round reaches a particular booster point or level, the processor 112, 112a, 112b can output an award equal to at least the Safe Zone Prize, which is illustrated as a multiple of the user's wager at the time of entering the bonus round.

In at least some embodiments, every five collected tokens lead to either a booster point reward, or a level increase. For example, when the processor 112, 112a, 112b has output five tokens on the display 110, 110a, 110b during level 0, the bonus event moves on to level 1. In at least some embodiments, one or more levels (such as level 0 shown in Table A) do not include any booster points. In accordance with that embodiment, only five tokens can be required to transition from the level without any booster points to the next level. In at least some other embodiments, level 0 can include a boost point level between zero and five tokens. Additionally or alternatively, a quantity of collected tokens leading to boost point reward or level increase can be different that five tokens.

In at least some embodiments, each level of the first reward system uses a unique reel set, indicated in the column entitled “Reel Set” of Table A. For example, a level 0 can use a reel set A, a level 1 can use a reel set B, a level 2 can use a reel set C, a level 3 can use a reel set D, a level 4 can use a reel set E, a level 5 can use a reel set F, a level 6 can use a reel set G, and a level 7 can use a reel set H. Using a unique reel set for each level can enable the provision of an improved or tailored experience to a user per level, as further explained below. In at least some embodiments, the higher the level, the more tokens must be collected to proceed to the next level. In at least some other embodiments, the quantity of tokens to be collected to proceed could be the same as a prior level, but the quantity of special symbols on the currently selected reel set can be less than the quantity of special symbols on the reel set used for the prior level.

In at least some embodiments, every time a new level is reached, the processor 112, 112a, 112b resets a quantity of spins available to a user to a predetermined number of free spins (e.g., three free spins). Resetting the quantify of spins can include resetting the spin meter value 358 to the predetermined number of free spins. So, when the bonus round reaches level 1, the user can start that level again with three free spins. At level 1, the user's Safe Zone Prize can be 5 (as shown in the TABLE A), meaning that the processor 112, 112a, 112b will output an award equal to five times their wager if the bonus round terminates at this point. According to some embodiments, ten tokens must now be collected for the bonus round to transition to the next level, i.e., level 2. The processor 112, 112a, 112b switching to a different reel set (e.g., a reel set B) can enable the user to reach this required number of tokens more easily. In addition, level 1 can be the first level with a booster point, e.g., when five tokens have been collected. When processor 112, 112a, 112b has output five tokens during level 1, the processor 112, 112a, 112b can output a secondary reward because the bonus round has reached the booster point 1.1. In at least some embodiments, the quantity of remaining free spins is output on the display 110, 110a, 110b (e.g., in a spin meter (e.g., a spin meter 706 shown in FIG. 7A, FIG. 7B, and/or FIG. 7C).

In at least some embodiments, the secondary reward can be randomly selected from the group comprising one or more of extra free spins, extra tokens, activate a Safe Zone Prize corresponding to the particular booster point, and/or other rewards and/or prizes.

At the first booster point (Booster Point 1.1), the safe zone prize can be 8 (as shown in TABLE A). Thus, if the secondary award awarded at Booster Point 1.1 is the activation of the Safe Zone Prize, the user's new Safe Zone Prize can equal 8 times their current bet, instead of the 5 associated with level 1 by default. The user can then continue playing, knowing that if the bonus round does not reach the next level, the processor 112, 112a, 112b will output an award equal to 8 times their wager. If the Safe Zone Prize is not awarded, the player's guaranteed winnings can remain at 5 times their wager. In at least some embodiments, a Safe Zone Prize comprising a multiplier is intermediate to a multiplier associated with a current level and the next level.

If the computing system awards extra tokens at Booster Point 1.1, it can award a quantity of tokens between 1 to N tokens, inclusive. As an example, N tokens can be 10 tokens. The quantity of tokens can be randomly chosen by a random number generator (RNG) or could be fixed based on a particular level and/or booster point. These extra tokens can be enough to increase the level of the bonus round or reach a further booster point (as applicable to the current level and number of tokens already awarded by the computing system).

If the computing system 100, 100a, 100b outputs additional free spins at Booster Point 1.1, such additional free spins can be added to the user's remaining free spins (e.g., added to the spin meter value 358). Alternatively, if a threshold level of tokens are collected to move to a next level, the computing system 100, 100a, 100b can reset the user's free spins (e.g., the spin meter value 358) to a quantity of free spins determined by the computing system 100, 100a, 100b upon advancing to such next level. As an example, the computing system 100, 100a, 100b can determine the quantify of free spins based on a default number of free spins (e.g., three free spins) or based on a random number using an RNG. In at least some embodiments, a bonus round can play out automatically until all free spins have been used, when the bonus round will terminate.

If, after Booster Point 1.1 has been reached, a further five tokens are collected (i.e., ten tokens in total during level 1), the bonus event can move on to level 2. The safe zone prize upon reaching level 2 is shown as 15 in TABLE A. Thus, when the bonus round ends, the computing system 100, 100a, 100b can output an award equal to at least 15 times a wager. In at least some embodiments, all booster points operate in the same way as Booster Point 1.1 discussed above.

In at least some embodiments, each level of the bonus round has a quantity of booster points equal to a number of the level (i.e., level 2 has two booster points, level 3 has three booster points, level 4 has four booster points, level 5 has five booster points, level 6 has six booster points, and level 7 has seven booster points).

In at least some embodiments, the computing system 100, 100a, 100b outputs an award upon reaching each booster point. In at least some of those embodiments, the award output by the computing system 100, 100a, 100b includes a randomly selected secondary prize.

The bonus round can progress through the available levels until a user runs out of free spins, or until an end of the highest level (e.g., the level 7) is reached (e.g., as shown in TABLE A, this would require 40 tokens to be collected in level 7). Based on Table A, at the end of level 7, the computing system 100, 100a, 100b will award a jackpot prize equal to a multiplier 10,000 times the user's wager. Other examples of the multiplier and/or the jackpot prize are also possible.

In at least some embodiments, the computing system 100, 100a, 100b resets the quantity of free spins available to a user (e.g., resets the spin meter value 358) to a predetermined number (e.g., three free spins) when advancing to a next level, even if the spin meter value 358 is greater than 1 (i.e., a user has free spins left over). In at least some other embodiments, a user's spins carry over to a next level (e.g., the computing system 100, 100a, 100b increments the spin meter value 358 by aforementioned predetermined number).

In at least some embodiments, upon reaching a new level, the computing system 100, 100a, 100b resets the number of tokens collected by a user (e.g., resets the token value 362 to zero). In accordance with those embodiments, a new level starts with 0 tokens. If, for example, a user needs two tokens to progress to a next level, and the user lands four tokens or is awarded four tokens at a booster point, the computing system 100, 100a, 100b does not allow a user to use two of those tokens, as they would start the next level with zero tokens. In at least some other embodiments, the computing system 100, 100a, 100b carries surplus tokens over to a next level. Based on the example in which a user needs two tokens to progress to a next level, and the user lands four tokens or is awarded four tokens at a booster point, the computing system 100, 100a, 100b advances to the next level with the token value set to two (e.g., two tokens).

In at least some embodiments, the reel set in use in the bonus round can be unique to each particular level. This can allow a developer to customize a user's experience for each level, possibly providing more tokens in the reel sets that can land and allow the user to transition to a next level more easily or add more high value symbols in specific levels. Special symbols can be provided on some levels, further building a user's anticipation levels and tailoring their experience to emphasise the user's progression through the levels. In some embodiments, reel sets can be randomly selected from a set of available reel sets for each level.

In at least some embodiments, the computing system 100, 100a, 100b outputs awards based on symbols being displayed according to a particular pattern after the reels stop spinning after a free spin during a bonus round. For example, landing three or more particular symbols in in a particular pattern within a symbol display portion (e.g., on a particular payline or payway), can result in the computing system 100, 100a, 100b outputting an award based on how the computing system 100, 100a, 100b outputs awards during events other than the bonus round. The computing system 100, 100a, 100b can output such awards into a player's account/wallet/credit balance immediately or can be combined with a final Safe Zone Prize the computing system 100, 100a, 100b outputs at the end of the bonus round.

The computing system 100, 100a, 100b can output on the display 110, 110a, 110b an indication of an award (e.g., a Safe Zone prize) corresponding to a current booster point and/or level. As an example, the award indicator can include an indication of a “guaranteed prize” or the like, that has been achieved during play of the bonus round. The computing system 100, 100a, 100b can also output an indication of the current level on the display 110, 110a, 110b (see, e.g., a current level display 705 shown in FIG. 7A, FIG. 7B, and/or FIG. 7C). The computing system 100, 100a, 100b can also output an indication of the booster point most-recently achieved and/or the number of booster point(s) that have been achieved in a particular level), to guide a user of the bonus round progressing towards completion. The computing system 100, 100a, 100b can also output on the display 110, 110a, 110b awards from previous booster points. In at least some embodiments, the computing system 100, 100a, 100b can output an additional award based on a predetermined number of secondary rewards that have been achieved. For example, if the computing system 100, 100a, 100b has output additional tokens three times in a row, the computing system 100, 100a, 100b can output a bonus award of, for example, 3 additional free spins.

While the computing system 100, 100a, 100b can be configured to output rewards based upon a fixed number of collected tokens (e.g., five tokens, as shown in Table A), in different embodiments, the computing system 100, 100a, 100b can output awards based on different quantities of collected tokens for different booster points and/or different levels. As an example, the computing system 100, 100a, 100b can output awards based on a first number of collected tokens (e.g., three tokens) for a first level, and on a second number of collected tokens (e.g., four tokens) for a second level.

Next, FIG. 6 is a flow chart showing a set 600 of functions of that can be carried out using the computing system 100 of FIG. 1A or the computing system 100a and/or the computing system 100b. A method of the example embodiments can include one or more functions of the set 600 and/or a portion of one or more functions of the set 600. Additionally, the order in which the functions of set 600 are illustrated in FIG. 6 and described below is not intended to be limiting. Moreover, performing a method based on the set 600 can include performing one or more of the functions multiple times.

Accordingly, a method based on function(s) of the set 600 can include a computer-implemented method involving a software application executed by the computing system 100b on behalf of the computing system 100b with a display screen. The software application involves graphically displaying, on vertical symbol display segments of the display screen, animations that simulate spinning a plurality of reels. A memory 114a of the computing system 100a can store, a global symbol group including a plurality of symbols. Subsets of the global symbol group and/or the plurality of symbols are displayable in a respective vertical symbol display segment of the display screen. The determinations made as part of the set 600 can be made by the processor 112, 112a, 112b.

Block 602 includes outputting a base event. Outputting the base event can include displaying reels on the display 110, 110a, 110b. The processor 112, 112a, 112b can cause the displayed reels to spin and to stop with a combination of symbols displayed on patterns defined for the base event. The processor 112, 112a, 112b can select symbols from the symbols 353 and/or a from a table, such as the global symbol group table 300. In at least some implementations, the selection of symbols can include selecting certain portions of the reels to be the portions output on the display.

Next, block 604 including triggering a feature event (e.g., a bonus event or bonus round). In at least some embodiments, the processor 112, 112a, 112b determines the feature event is triggered based on the symbols display on the display 110, 110a, 110b after the reels stop spinning for the base event, and/or based on at least some of the symbols being display in certain patterns active for the base event. In at least some embodiments, triggering the feature event includes the processor 112, 112a, 112b outputting on the display a notification that the feature event has been triggered. In at least some embodiments, the triggered feature event starts automatically. In at least some other embodiments, the triggered feature event starts after a particular USC is selected. The aforementioned notification can indicate that the particular USC is to be selected before the triggered feature event starts.

Next, at block 606, the feature event starts and/or the computing system 100, 100a, 100b, awards a quantity of free spins. As an example, the quantity of free spins is three free spins. Other examples of the quantity of free spins are possible. Awarding the free spins can include setting the spin meter value 358 to the quantity of spins. In at least some embodiments, the quantity of free spins is a default, predetermined quantity of free spins. In at least some other embodiments, the quantity of free spins is determined using an RNG from a particular range, such as a range of 1 to 5 inclusive.

Next, block 608 includes decreasing a spin counter. The processor 112, 112a, 112b can decrease the spin counter in response to determining a USC selectable to cause the processor 112, 112a, 112b to spin the reels has been selected. As an example, decreasing the spin counter can include decreasing the spin meter value 358. Decreasing the spin meter can include decrementing the spin meter value 358 by one spin.

Next, block 610 includes using a reel set selected for a particular level of a bonus round to display on the display 110, 110a, 110b a set of spinning reels and an outcome based on the symbols of the set of reels output on the display 110, 110a, 110b. The processor 112, 112a, 112b can select the reel set in response to transitioning from a first operating state corresponding to a prior level of a bonus round to a second operating state corresponding to a next level of the bonus round. Upon transitioning, the next level becomes a current level of the bonus round. In other words, the processor 112, 112a, 112b can select the reel set based on a current level of the bonus round. In at least some embodiments, a method based on the set 600 includes advancing directly to block 616 after block 610. In other words, in those implementations, the functions at block 612 and block 614 are not performed. In other embodiments, a method based on the set 600 includes advancing to block 612 after block 610.

Next, block 612 includes determining whether the symbols displayed on the display 110, 110a, 110b result in a win based on a particular pattern (e.g., a particular payline and/or payway). In at least embodiments, multiple patterns can be active based on a wager received by the computing system 100, 100a, 100b such that block 612 includes determining whether the symbols displayed on the display 110, 110a, 110b within the active patterns results in a respective win.

Next, block 614 includes the computing system 100, 100a, 100b outputting an award if the determination at block 612 indicates a win. As an example, the computing system 100, 100a, 100b can increment the credit value 354 by a quantity of credits corresponding to the winning particular pattern. The award can include an award based on aggregating individual awards resulting from wins on respective patterns.

Next, block 616 includes determining a number of tokens landed (e.g., determining how many tokens are displayed within the symbol display portion of a GUI output on the display 110, 110a, 110b after the set of reels stops spinning). The determination at block 616 can be made without outputting an award at block 614 if the determination at block 612 indicates no wins based on a particular pattern, or after outputting an award at block 614 if the determination at block 612 indicates one or more wins based on a particular pattern.

Next, if the determination at block 616 indicates that one or more tokens landed, then block 618 can include adding the tokens to a token counter. As an example, adding the tokens can include the processor 112, 112a, 112b incrementing the token value 362 by the quantity of tokens that landed within the symbol display portion.

Next, block 620 includes determining whether a booster point was reached. As an example, the processor 112, 112a, 112b can make that determination by comparing the token value 362 to a quantity of collected tokens corresponding to a next booster point to be achieved. Table A shows examples of the quantity of collected tokens. For example, if the computing system 100, 100a, 100b is operating in an operating state for level 3 and the booster point 3.1 has not yet been reached, then the processor 112, 112a, 112b can compare the quantity of collected tokens needed to reach the booster point 3.1 (i.e., 5 collected tokens) to the token value 362. As another example, if the booster point 3.1 has already been achieved, then the processor 112, 112a, 112b can compare the quantity of collected tokens needed to reach the booster point 3.2 (i.e., 10 collected tokens) to the token value 362.

If the determination at block 620 indicates the booster point was reached, the processor 112, 112a, 112b can determine an award (e.g., one or more awards) for reaching the booster point. Determining the award can include making one or more determinations shown at block 622, 626, 628.

Next, block 622 includes determining whether to award one or more free spins. If one or more spins is to be awarded, a method based on the set 600 can continue at block 624. Otherwise, the method can continue at block 626.

Block 624 includes increasing a free spins counter (e.g., the spin meter value 358). A method based on the set 600 can the continue at block 608.

Block 626 includes determining whether to award any tokens. If one or more tokens is to be awarded, a method based on the set 600 can continue at block 618, where the one or more tokens are added to the token counter (e.g., the token value 362). Otherwise, the method can continue at block 628.

Block 628 includes determining whether a next safe zone has been reached. If the next safe zone has been reached, a method based on the set 600 can proceed at block 630. Otherwise, the method can continue at block 629, which indicates the method continues at block 608.

Block 630 included upgrading a safe zone award based on the next safe zone that has been reached. Based on Table A, a next safe zone can be reached when a next level or a next booster point has been reached. Upon completing block 630, a method based on the set 600 can continue at block 608 to decrease the spin counter.

Next, referring again to block 620, if a booster point is not reached, a method based on the set 600 can continue at block 632.

Block 632 includes determining whether a next level threshold has been reached. If a determination at block 632 indicates that a next level threshold has been reached, then a method based on the set 600 can proceed to block 634.

Block 634 includes determining whether the highest level of the bonus event has been reached. If the determination at block 634 indicates the highest level has been reached, a method based on the set 600 can proceed to block 636, and the computing system 100, 100a, 100b can terminate the feature event and output any remaining award earned during performance of the feature event. Otherwise, the determination at block 634 indicates the highest level has not been reached, then a method based on the set 600 can proceed to block 638.

Block 638 includes proceeding to a next level of the feature event. Proceeding to the next level of an event can include the processor 112, 112a, 112b switching to an operating state corresponding to the next level. As an example, the operating state corresponding the next level can include using a particular set of reels corresponding to the next level, resetting or incrementing the booster point value 359, resetting or incrementing the spin meter value 358, setting the current level value based on the next level, and/or resetting or incrementing the token value 362. As another example, block 638 can include resetting a spin counter to a predetermined number of spins (e.g., three free spins), resetting a token counter (e.g., resetting the token value 362 to zero) and/or upgrading a safe zone prize based on the next level that has been achieved. After performing the functions of block 638, a method based on the set 600 can continue at block 608.

Next, if a determination at block 632 indicates that a level threshold has not been reached, or if no tokens landed at block 616, then a determination can be made at block 642 as to whether any free spins remain. If one or more free spins remain, a method based on the set 600 can then proceed to block 608. If no free spins remain, a method based on the set 600 can then proceed to block 636 and the computing system 100, 100a, 100b can terminate the feature event and output any remaining award earned during performance of the feature event.

Next, FIG. 7A, FIG. 7B, and/or FIG. 7C show a GUI 700, in accordance with the example embodiments. The GUI 700 includes a symbol display portion 702 in which portions of a selected set of reels are displayed. The symbol display portion 702 is configured to have three rows, five columns, and fifteen symbol positions in which symbols, such as a special symbol can be displayed. As an example, a special symbol can be classified as a token 704. In at least some other embodiments, the symbol display portion of the GUI can include a different number of rows, a different number of columns, and/or a different number of symbol positions. As an example, the symbol display portion can include three rows, three columns, and nine symbol positions. As another example, the symbol display portion can include four rows, five columns, and twenty symbol positions. Other examples are also possible.

The GUI 700 can include one or more from among: a current level display 705, a spin meter 706, a token meter 707, a booster point meter 710, a credit meter 714, a payout meter 716, a payment meter 718, or a tokens per level icon 720.

The spin meter 706 can show how many free spins remain. As an example, the spin meter 706 can indicate the spin meter value 358. The processor 112, 112a, 112b can decrement the spin meter 706 (as well as the spin meter value 358) each time a USC is selected to cause a set of reels to spin. The processor 112, 112a, 112b can increment the spin meter (as well as the spin meter value 358) in response to receiving a reward of one or more free spins, reaching a next booster point, or a next level of the feature event described herein. In at least some other embodiments, the spin meter 706 can indicate how many free spins have been used for a current level. In at least some other embodiments, the spin meter 706 can indicate how many free spins remain for the current level and how many free spins have been used for the current level. Furthermore, in at least some embodiments, the spin meter 706 can indicate how many free spins remain for the current level and/or how many free spins have been used for the current level using non-numeric icons instead of or in addition to numeric indicator(s).

The token meter 707 can indicate how many times the token 704 has been output on the display 110, 110a, 110b during a particular level (e.g., the level indicated by the current level display 705) and/or at a particular booster point of an event performed by the computing system 100, 100a, 100b. As an example, the token meter 707 can indicate the token value 362. In at least some embodiments, the token meter 707 indicates how many tokens need to be collected before the next award (whether primary or secondary) and/or the next level and/or booster point is reached.

As an example, either a new level or a booster point can be reached after every five tokens. In accordance with that example, the token meter 707 includes an icon 708A, 708B, 708C, 708D, 708E corresponding to each of five tokens. As shown in FIG. 7A, FIG. 7B, and/or FIG. 7C, the icon 708A, 708B, 708C, 708D, 708E includes an icon matching the token 704 (in appearance rather than in size). FIG. 7A, FIG. 7B, and FIG. 7C include line segments extending from an outer circumference of the icon 708A, 708B and bolder lines to represent that the icon 708A, 708B is highlighted. In contrast, FIG. 7A, FIG. 7B, and FIG. 7C does not include line segments extending from an outer circumference or bolder lines for the icon 708C, 708D, 708E to represent that the icon 708C, 708D, 708E is not highlighted. In at least some embodiments, the highlighted icons indicate how many instances of the token 704 have appeared within the symbol display portion 702 for the current level or booster point, and the non-highlighted icons indicate how many additional instances of the token 704 need to appear within the symbol display portion 702 to advance to the next level or booster point. In other embodiments, the use of highlighted and non-highlighted icons can be switched. In still other embodiments, instead of or in addition to using highlighted and non-highlighted icons, the token meter 708 can use numeric indicators to indicate the state of the computing system advancing to the next level and/or booster point.

The booster point meter 710 can indicate how many booster points are within a current level of the feature event and/or indicate a status of achieving booster points within the current level. In accordance with the embodiments shown in FIG. 7A to FIG. 7C, each icon (shown as a square populated with an X) corresponds to a respective booster point. For example, in FIG. 7A, for level one shown in TABLE A, the booster point meter 710 includes an icon 711 for booster point 1.1. In FIG. 7B, for level two shown in TABLE A, the booster point meter 710 includes the icon 711 and an icon 713 for booster point 2.1, 2.2, respectively.

In FIG. 7C, for level seven shown in TABLE A, the booster point meter 710 includes the icon 711, 713 and an icon 715, 717, 719 for booster point 7.1, 7.2, 7.3, 7.4, 7.5, respectively.

In at least some embodiments, the icon 711, 713, 715, 717, 719 can include a first character (e.g., an “X”) to indicate that the corresponding booster point has not been reached yet, and a second character (e.g., a “+”) to indicate that the corresponding booster point has been reached. The booster point meter 710 can assist a user when the token meter 707 is configured to display less than all tokens required to advance to a next level. For example, if the token meter 707 is configured to show a maximum of five collected tokens and the tokens per level icon 720 indicates twenty tokens for level three, the booster point meter 710 and the token meter 707 can indicate how many more tokens are needed before advancing to a next, higher level and corresponding award.

The processor 112, 112a, 112b can cause the icon 711, 713, 715, 717, 719 to display the first character (e.g., the “X”) upon changing its operating state and advancing to the next level. As another example, the icon 711, 713, 715, 717, 719 can be an un-highlighted to represent the corresponding booster point has not been reached and can be highlighted to represent the corresponding booster point has been reached, or vice versa.

The current level display 705 can indicate the current level of the feature event, as well as levels that have already been achieved and levels that have not yet been achieved. In FIG. 7A, FIG. 7B, and FIG. 7C, the current level is indicated by the line segments around an outer circumference of a circular portion of an icon 712 to represent that the icon 712 is highlighted. Further, in FIG. 7A, FIG. 7B, and FIG. 7C, the levels that have already been achieved are represented by an icon 721 (e.g., an un-highlighted icon). Furthermore, in FIG. 7A, FIG. 7B, and FIG. 7C, the levels that have not yet been achieved are represented by an icon 722 (e.g., a highlighted icon).

As shown in FIG. 7A, current level display 705 shows the current level as level one (see TABLE A). In FIG. 7B, current level display 705 shows the current level as level two (see TABLE A). In FIG. 7C, current level display 705 shows the current level as level seven (see TABLE A). A person having ordinary skill in the art will understand that additional instances of the GUI 700 showing the current level display 705 with the icon 712 indicating the current level is level zero, three, four, five, six, or eight.

The current level display 705 can also indicate a multiplier applicable to each level of the feature event. As an example, the multiplier can correspond to a multiplier value shown in the Safe Zone column in the TABLE A, for each level.

The credit meter 714 can indicate how many credits are available to a user of the computing system 100, 100a, 100b. The processor 112, 112a, 112b can increment the credit meter upon receiving a payment from an acceptor and/or in response to a reward being earned during some event performed by the computing system 100, 100a, 100b. As an example, the credit meter 714 can be incremented by an amount shown in the payout meter 716. The processor 112, 112a, 112b can decrement the credit meter 714 upon receiving a wager and/or in response to transferring a payment (e.g., bills or coins) via the user interface 104, 104a, 104b. As an example, the credit meter 714 can be decremented by an amount shown in the payment meter 718. As another example, the credit meter 714 can indicate the credit value 354. The payout meter 716 can indicate an amount of an award earned during an event in which the GUI 700 is displayed. The payment meter 718 can indicate an amount of a wager entered using the user interface 104, 104a, 104b for an event in which the GUI 700 is displayed.

Notably, the functions of operating multiple concurrent reward systems, switching output between different reward systems, and/or changing reel sets necessitate computer implementation. Without computer implementation, concurrently operating and switching output between different reward systems would not be possible due to the fixed nature of non-computerized implementations. Similarly, changing reel sets would be impractical in a non-computerized implementation because it would require physical changes to the computing system and lengthy pauses in carrying out events via the computing system. In contrast, the computer implementation herein allows two or more reward systems to operate at the same time without any need to switch out physical components of a computer system. Similarly, digital reel sets can be changed instantly with no disruption to performing events via the computing system. Consequently, these features of the disclosure herein would not exist but for computer technology.

Particularly, the embodiments herein solve a technical problem of how to enhance volatility, excitement, and anticipation for users through the use of multiple, concurrent reward systems and changing reel sets. The functions of operating multiple concurrent reward systems, switching output between different reward systems, and/or changing reel sets would be prohibitively complex and expensive to implement on a traditional machine with mechanical reels. In effect, the present approach can be seen as providing implementations which increase the number and variety of possible outcomes in a reel-based slot event.

Further, these features are an improvement to reel-based event technology. Since the symbols appearing on each reel are fixed and cannot be changed during mechanical reel-based outcome events, the functions of operating multiple concurrent reward systems, switching output between different reward systems, and/or changing reel sets could not appear in such outcome events. Due to this technological limitation, users can become disinterested in these basic reel-based outcome events. Computer implementation, however, facilitates the integration of these features into reel-based outcome events, resulting in outcome event dynamics that would otherwise be unavailable. Consequently, the disclosure herein is a technological improvement to reel-based outcome events.

Furthermore, the embodiments can include performing the functions of operating multiple concurrent reward systems, switching output between different reward systems, and/or changing reel sets using a server computing system and client computing system using a communication network to carry communications including instructions and/or data to carry out the functions. As an example, the client computing system can include user-selectable controls that are selectable to trigger performance of an outcome event. Moreover, a processor at the client computing system can receive inputs from devices operatively coupled to the processor, such as an acceptor, and can control devices outside of the processor during performance of the outcome event, such as a display or speaker.

Furthermore still, in some embodiments, a processor at the server computing system can determine an outcome for an outcome event and transmit data for displaying a representation of the outcome event on a display screen at the client computing system. In at least some embodiments, the data for displaying a representation of the outcome event can include an index value to some content already stored at the client computing system so that the server computing system does not need to transmit that content each time the client computing system is to display that content during performance of an outcome event. For example, the index value can include a value indicative of a particular animation of the animations 356 to display when the client computing system is operating in a particular operating state, such as the operating state for the current level shown in the current level display 705. As another example, the index value can include a value indicative of a particular reel set to display within the symbol-display-portion 402, 702.

The GUI 700 or another GUI including aspects of the GUI 700 can be displayed during performance of a method, such as a method based on the set 600 discussed with respect to FIG. 6 or a set 900 discussed with respect to FIG. 9A to FIG. 9E. A “token” discussed with respect to the set 600 can be and/or include the special symbol (i.e., the token 704) discussed with respect to FIG. 7A, FIG. 7B, and/or FIG. 7C. A “particular symbol” discussed with respect to the set 900 can be and/or include the special symbol (i.e., the token 704) discussed with respect to FIG. 7A, FIG. 7B, and/or FIG. 7C.

Next, FIG. 8 is a block diagram of a computing system 800 configured for multi-level progression with a series of software-based reel events, in accordance with the example embodiments. In at least some implementations, the computing system 800 can include one or more computing platforms (i.e., computing platform(s) 802). The computing platform(s) 802 can be configured to communicate with one or more remote platforms of the remote platform(s) 804 according to a client/server architecture, a peer-to-peer architecture, and/or other architectures. The remote platform(s) 804 can be configured to communicate with other remote platforms via computing platform(s) 802 and/or according to a client/server architecture, a peer-to-peer architecture, and/or other architectures. Users can access the computing system 800 via the remote platform(s) 804. According to at least some embodiments, the one or more of computing platform(s) 802, the remote platform(s) 804, and/or the other components of the computing system 800 can be the same as or similar to one or more components of the computing system 100 of FIG. 1i, the computing system 100a and/or the computing system 100b of FIG. 2, and/or other computing resources disclosed herein.

Computing platform(s) 802 can be configured by machine-readable instructions 806. Machine-readable instructions 806 can include one or more instruction modules. The instruction modules can include computer program modules. The instruction modules can include one or more from among a user interface providing module 808, a spin outputting module 810, a total determination module 812, a reward outputting module 814, a processor transitioning module 816, a payment amount receiving module 818, and/or other instruction module(s).

The user interface providing module 808 can be configured to provide, by a processor, a graphical user interface including multiple symbol positions arranged in multiple rows and multiple columns. The multiple rows can include at least three rows. The multiple columns can include at least five columns. The graphical user interface can include multiple particular patterns. Each particular pattern can include multiple symbol positions across the multiple columns. The graphical user interface can include multiple particular patterns. Each particular pattern can include multiple symbol positions across the multiple columns. The graphical user interface can include multiple particular patterns. Each particular pattern can include multiple symbol positions across the multiple columns. Providing the graphical user interface can include providing the graphical user interface on a touch display screen. Providing the graphical user interface can include providing the graphical user interface on a display screen. The graphical user interface can include multiple particular patterns. Each particular pattern can include multiple symbol positions across the multiple columns. A global symbol group including a plurality of symbols can be stored, subsets of which are displayable in a respective column of the multiple columns. Each of the first plurality of symbols can be associated with one of the multiple symbol positions. Each pattern can include three or more symbol positions across consecutive columns of the multiple columns. Each pattern can include three symbol positions across consecutive columns of the multiple columns. The user can select a control selectable to initiate the next spin includes a user interface component remote from the display screen and operatively coupled to the processor. The processor can output a reward for the winning pattern. The graphical user interface can output an indication the processor is operating in the next operating state.

In at least some embodiments, each column of the multiple columns arranged to depict a spinnable reel of a reel set for all events of multiple events of a series of feature events include a reel from a single reel set. In at least some other embodiments, each column of the multiple columns arranged to depict a spinnable reel of a reel set for events of a series of feature events can be selected from among a plurality of reel sets. The processor can transition to a different operating state for use with each different reel set of the plurality of reel sets. By way of non-limiting example, the plurality of reel sets can include a first reel set and a second reel set. The processor can determine for each particular pattern and each spin of the reels of the first reel set and each spin of the reels of the second reel set whether symbols in the symbol positions of the particular pattern form a winning pattern. By way of non-limiting example, each spinnable reel includes multiple different symbols from a set of symbols, the first reel set can have one or more different reels than the second reel set. By way of non-limiting example, the different reels can have different combinations of symbols, and the set of symbols including a particular symbol.

The spin outputting module 810 can be configured to output, on the graphical user interface while the processor operates in a first operating state, one or more spins of the first reel set selected for the first operating state. The processor can be transitioned from a prior operating state to the first operating state. The processor can be transitioned from a prior operating state to the first operating state. A first payment amount can be received at an input device configured to input a payment amount. The multiple special symbols can function as scatter symbols. The scatter symbols can effectuate a trigger event irrespective of positions of the scatter symbols among the multiple symbol positions. The user can selectable control selectable to initiate the next spin includes a user selectable control displayed on the touch display screen. The spin outputting module 810 can be configured to output, on the graphical user interface while the processor operates in the second operating state, one or more spins of the second reel set selected for the second operating state. The spin outputting module 810 can be configured to output, on the graphical user interface while the processor operates in the third operating state, one or more spins of a third reel set selected for the third operating state. The spin outputting module 810 can be configured to output, on the graphical user interface while the processor operates in the fourth operating state, one or more spins of a fourth reel set selected for the fourth operating state.

The total determination module 812 can be configured to determine, by the processor based on the one or more spins of the first reel set selected for the first operating state, a first running total of a number of times the particular symbol is displayed on the graphical user interface while the processor is operating in the first operating state. The total determination module 812 can be configured to determine, by the processor, whether the first running total exceeds one or more of a first threshold of a first reward system or a first threshold of a second reward system. The second reward system can include multiple levels. Each level of the second reward system can correspond to a different reel set of the plurality of reel sets. The multiple levels can be ordered in a sequence beginning at a lowest level and ending at a greatest level. The multiple levels can include one or more intermediary levels within the ordered sequence.

A reward corresponding to reaching each level of the multiple levels of the second reward system can include a predetermined number of spins. A remaining number of spins can be reset to the predetermined number of spins at each level of the second reward system. A remaining number of spins at each level of the second reward system can be equal to the predetermined number of spins plus any free spins remaining in a previous level of the second reward system. A reward associated with the first reward system can provide a level upgrade in the second reward system. A reward associated with the first reward system can be randomly chosen and/or modified from a predetermined list of available rewards corresponding to the first reward system. By way of non-limiting example, the predetermined list of available rewards corresponding to the first reward system can include one or more of additional free spins, additional collected special symbols, or activation of a special reward. The second reward system can include multiple different levels. The graphical user interface can output, while the processor operates in the first operating state, a level display that indicates a first level of the second reward system is a current level of the second reward system in use by the processor. A primary reward can be associated with each level of the multiple different levels of the second reward system. The primary reward associated with each level of the second reward system can be different for different ones of the multiple levels of the second reward system.

The total determination module 812 can be configured to determine, by the processor based on the one or more spins of the second reel set selected for the second operating state, a second running total of a number of times the particular symbol is displayed on the graphical user interface while the processor is operating in the second operating state. The total determination module 812 can be configured to determine, by the processor, whether the second running total exceeds one or more of a second threshold of the first reward system or a second threshold of the second reward system. The second threshold of the second reward system can be greater than the first threshold of the second reward system. The second threshold of the second reward system can be greater than the first threshold of the second reward system. The processor can determine the second running total is less than the second threshold of the second reward system and a number of remaining spins in a spins counter for the second operating state is zero and then transitioning the processor to a next operating state. The total determination module 812 can be configured to determine, by the processor based on the one or more spins of the third reel set selected for the third operating state, a third running total of a number of times the particular symbol is displayed on the graphical user interface while the processor is operating in the third operating state.

The total determination module 812 can be configured to determine, by the processor, whether the third running total exceeds one or more of a third threshold of the first reward system or a third threshold of the second reward system. The third threshold of the second reward system can be greater than the second threshold of the second reward system. The third threshold of the second reward system can be greater than the second threshold of the second reward system. The total determination module 812 can be configured to determine, by the processor based on the one or more spins of the fourth reel set selected for the fourth operating state, a fourth running total of a number of times the particular symbol is displayed on the graphical user interface while the processor is operating in the fourth operating state. The total determination module 812 can be configured to determine, by the processor, whether the fourth running total exceeds one or more of a fourth threshold of the first reward system or a fourth threshold of the second reward system. The fourth threshold of the second reward system can be greater than the third threshold of the second reward system.

The reward outputting module 814 can be configured to output, by the processor, at least one reward in response to the first running total exceeding one or more of the first threshold of the first reward system or the first threshold of the second reward system.

The processor transitioning module 816 can be configured to transition, in response to the first running total exceeding the first threshold of the second reward system, the processor from operating in the first operating state to a second operating state. Transitioning the processor from operating in the first operating state to the second operating state can include selecting the second reel set to use instead of the first reel set. Transitioning the processor from operating in the first operating state to the second operating state can include incrementing a spins counter by a predetermined number of spins. Transitioning the processor from operating in the first operating state to the second operating state can include outputting, on the graphical user interface, an icon indicating a quantity of spins indicated by the spins counter. Transitioning the processor from operating in the first operating state to the second operating state can include activating a user selectable control selectable to initiate a next spin of spinnable reels in the multiple columns. The graphical user interface can output, while the processor operates in the second operating state, the level display that indicates a second level of the second reward system is the current level of the second reward system in use by the processor. The processor transitioning module 816 can be configured to transition, in response to the second running total exceeding the second threshold of the second reward system, the processor from operating in the second operating state to a third operating state. The processor transitioning module 816 can be configured to transition, in response to the third running total exceeding the third threshold of the second reward system, the processor from operating in the third operating state to a fourth operating state.

The processor transitioning module 816 can be configured to transition the processor from a prior operating state to the first operating state. Transitioning from the prior operating state to the first operating state can be conditioned on a trigger condition appearing on the graphical user interface while the processor is operating in the prior operating state. As an example, the prior operating state can include an operating state in which the computing system 800 outputs a base event on a display. The trigger condition can include a landing of a predetermined quantity of special symbols (e.g., three special symbols) within the multiple symbol positions. The trigger condition can include a particular combination of symbols from the set of symbols appearing within a particular pattern of the graphical user interface. Transitioning from the prior operating state to the first operating state can be conditioned on a trigger condition appearing on the graphical user interface while the processor is operating in the prior operating state. The processor can be transitioned to the prior operating state in response to receiving the first payment amount.

The reward outputting module 814 can be configured to output, by the processor(s) 830, at least one reward in response to the second running total exceeding one or more of the second threshold of the first reward system or the second threshold of the second reward system. The reward outputting module 814 can be configured to output, by the processor(s) 830, at least one reward in response to the third running total exceeding one or more of the third threshold of the first reward system or the third threshold of the second reward system. The reward outputting module 814 can be configured to output, by the processor(s), at least one reward in response to the fourth running total exceeding one or more of the fourth threshold of the first reward system or the fourth threshold of the second reward system.

The payment amount receiving module 818 can be configured to receive, at an input device configured to input a payment amount, a first payment amount. The processor can be transitioned to a prior operating state in response to receiving the first payment amount. The input device can include an acceptor. By way of non-limiting example, the acceptor can include a paper money acceptor, a coin acceptor, a token acceptor, a validator, and/or a card reader. The input device can include a user-selectable control on a touch-sensitive screen of a display. A payment must be received while the processor can operate in the next operating state before the processor transitions back to an operating state in which the processor is configured to output a reward based on spinning the reels.

In some implementations, the particular pattern can include a particular payline of the multiple particular patterns. In some implementations, by way of non-limiting example, each of the multiple particular patterns can include a horizontally extending pattern, a diagonally extending pattern, or a combination of a horizontally extending pattern and a diagonally extending pattern. In some implementations, the particular pattern can include a particular payway of the multiple particular patterns. In some implementations, a first plurality of symbols can be randomly determined.

In some implementations, the computing platform(s) 802, the remote platform(s) 804, and/or the external resources 826 can be operatively linked via one or more electronic communication links. For example, such electronic communication links can be established, at least in part, via a network such as the Internet and/or other networks. It will be appreciated that this is not intended to be limiting, and that the scope of this disclosure includes implementations in which the computing platform(s) 802, the remote platform(s) 804, and/or the external resources 826 can be operatively linked via some other communication media.

A given remote platform of the remote platform(s) 804 can include one or more processors configured to execute computer program modules. The computer program modules can be configured to enable an expert or user associated with the given remote platform to interface with the computing system 800 and/or the external resources 826, and/or provide other functionality attributed herein to the remote platform(s) 804. By way of non-limiting example, a given remote platform of the remote platform(s) 804 and/or a given computing platform of the computing platform(s) 802 can include one or more of a slot machine, a server, a desktop computer, a laptop computer, a handheld computer, a tablet computing platform, a NetBook, a Smartphone, a gaming console, and/or other computing platforms.

The external resources 826 can include sources of information outside of the computing system 800, external entities participating with the computing system 800, and/or other resources. In some implementations, some or all of the functionality attributed herein to the external resources 826 can be provided by resources included in the computing system 800.

The computing platform(s) 802 can include electronic storage 828, one or more processor(s) 830, and/or other components. The computing platform(s) 802 can include communication lines, or ports to enable the exchange of information with a network and/or other computing platforms. Illustration of the computing platform(s) 802 in FIG. 8 is not intended to be limiting. The computing platform(s) 802 can include a plurality of hardware, software, and/or firmware components operating together to provide the functionality attributed herein to the computing platform(s) 802. For example, the computing platform(s) 802 can be implemented by a cloud of computing platforms operating together as the computing platform(s) 802.

The electronic storage 828 can comprise non-transitory storage media that electronically stores information. The electronic storage media of the electronic storage 828 can include one or both of system storage that is provided integrally (i.e., substantially non-removable) with the computing platform(s) 802 and/or removable storage that is removably connectable to the computing platform(s) 802 via, for example, a port (e.g., a USB port, a firewire port, etc.) or a drive (e.g., a disk drive, etc.). The electronic storage 828 can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 828 can include one or more virtual storage resources (e.g., cloud storage, a virtual private network, and/or other virtual storage resources). The electronic storage 828 can store software algorithms, information determined by the processor(s) 830, information received from the computing platform(s) 802, information received from the remote platform(s) 804, and/or other information that enables the computing platform(s) 802 to function as described herein.

The processor(s) 830 can be configured to provide information processing capabilities in the computing platform(s) 802. As such, the processor(s) 830 can include one or more of a digital processor, an analog processor, a digital circuit designed to process information, an analog circuit designed to process information, a state machine, and/or other mechanisms for electronically processing information. Although the processor(s) 830 are shown in FIG. 8 as a single entity, this is for illustrative purposes only. In some implementations, the processor(s) 830 can include a plurality of processing units. These processing units can be physically located within the same device, or the processor(s) 830 can represent processing functionality of a plurality of devices operating in coordination. The processor(s) 830 can be configured to execute modules 808, 810, 812, 814, 816, and/or 818, and/or other modules. The processor(s) 830 can be configured to execute the modules 808, 810, 812, 814, 816, and/or 818, and/or other modules by software; hardware; firmware; some combination of software, hardware, and/or firmware; and/or other mechanisms for configuring processing capabilities on the processor(s) 830. As used herein, the term “module” can refer to any component or set of components that perform the functionality attributed to the module. This can include one or more physical processors during execution of processor readable instructions, the processor readable instructions, circuitry, hardware, storage media, or any other components.

It should be appreciated that although the modules 808, 810, 812, 814, 816, and/or 818 are illustrated in FIG. 8 as being implemented within a single processing unit, in implementations in which the processor(s) 830 includes multiple processing units, one or more of the modules 808, 810, 812, 814, 816, and/or 818 can be implemented remotely from the other modules. The description of the functionality provided by the modules 808, 810, 812, 814, 816, and/or 818 described below is for illustrative purposes, and is not intended to be limiting, as any of modules 808, 810, 812, 814, 816, and/or 818 can provide more or less functionality than is described. For example, one or more of the modules 808, 810, 812, 814, 816, and/or 818 can be eliminated, and some or all of its functionality can be provided by other ones of modules 808, 810, 812, 814, 816, and/or 818. As another example, the processor(s) 830 can be configured to execute one or more additional modules that can perform some or all of the functionality attributed below to one of the modules 808, 810, 812, 814, 816, and/or 818.

Next, FIG. 9A, FIG. 9B, FIG. 9C, FIG. 9D, and/or FIG. 9E is a flow chart showing a set 900 of functions of that can be carried out using the computing system 100 of FIG. 1A, the computing system 100a and/or the computing system 100b shown in FIG. 2, the computing system 800 of FIG. 8, the computing platform(s) 802, the remote platform(s) 804, and/or other computing resources. A method of the example embodiments can include one or more functions of the set 900 and/or a portion of one or more functions of the set 900. Additionally, the order in which the functions of set 900 are illustrated in FIG. 9A, FIG. 9B, FIG. 9C, FIG. 9D, and/or FIG. 9E and described below is not intended to be limiting.

Accordingly, a method based on function(s) of the set 900 can include a computer-implemented method involving a software application executed by the computing system (e.g., the computing system 100 of FIG. 1A, the computing system 100a and/or the computing system 100b shown in FIG. 2, the computing system 800 of FIG. 8, the computing platform(s) 802, the remote platform(s) 804, and/or other computing resources) with and/or in communication with a display screen. The software application involves graphically displaying, on vertical symbol display segments of the display screen, animations that simulate spinning a plurality of reels. A memory (e.g., the memory 114a of the computing system 100a, the electronic storage 828 of the computing platform(s) 802, and/or other memories) can store, a global symbol group including a plurality of symbols. Subsets of the global symbol group and/or the plurality of symbols are displayable in a respective vertical symbol display segment of the display screen.

Furthermore, the set 900 refers to a “particular symbol.” The special symbol and token 704 discussed with respect to FIG. 7A, FIG. 7B, and/or FIG. 7C is an example of the particular symbol discussed with respect to the set 900. Furthermore still, the set 900 refers to a “processor.” The processor in the set 900 can, for example, include one or more from among: the processor 112, the processor 112a, the processor 112b, or the processor(s) 830.

FIG. 9A illustrates set 900, in accordance with one or more implementations.

Block 902 includes providing, by a processor, a graphical user interface including multiple symbol positions arranged in multiple rows and multiple columns. Each column of the multiple columns is arranged to depict a spinnable reel of a reel set. Each spinnable reel includes multiple different symbols from a set of symbols. The set of symbols includes a particular symbol. The functions of block 902 can be performed by one or more hardware processors configured by machine-readable instructions including a module that is the same as or similar to the user interface providing module 808, in accordance with the example embodiments. Furthermore, the GUI 700 shown in FIG. 7A, FIG. 7B, and/or FIG. 7C is an example of the graphical user interface provided by the processor at block 902.

Block 904 includes outputting, on the graphical user interface while the processor operates in a first operating state, one or more spins of the reel set for the first operating state. The functions of block 904 can be performed by one or more hardware processors configured by machine-readable instructions including a module that is the same as or similar to the spin outputting module 810, in accordance with the example embodiments. As an example, the reel set can include and/or be configured like the reel set 450 shown in FIG. 3C.

Block 906 includes determining, by the processor based on the one or more spins of the reel set for the first operating state, a first running total of a number of times the particular symbol is displayed on the graphical user interface while the processor is operating in the first operating state. The functions of block 906 can be performed by one or more hardware processors configured by machine-readable instructions including a module that is the same as or similar to the total determination module 812, in accordance with the example embodiments. As an example, the processor can track the first running total within the token value 362 and can determine the first running total, at least in part, by reading the token value 362.

Block 908 includes determining, by the processor, whether the first running total exceeds one or more of a first threshold of a first reward system or a first threshold of a second reward system. The functions of block 908 can be performed by one or more hardware processors configured by machine-readable instructions including a module that is the same as or similar to the total determination module 812, in accordance with the example embodiments. As an example, the processor can make this determination by comparing the token value 362 to the booster point value 359 and the level threshold 363 for the current level of the feature event.

Block 910 includes outputting, by the processor, at least one reward in response to the first running total exceeding one or more of the first threshold of the first reward system or the first threshold of the second reward system. The functions of block 910 can be performed by one or more hardware processors configured by machine-readable instructions including a module that is the same as or similar to the reward outputting module 814, in accordance with the example embodiments. As an example, the processor can output a reward from one or more of the rewards (e.g., awards) discussed at block 622, 626, 628 shown in FIG. 6.

Block 912 includes transitioning, in response to the first running total exceeding the first threshold of the second reward system, the processor from operating in the first operating state to a second operating state. The functions of block 912 can be performed by one or more hardware processors configured by machine-readable instructions including a module that is the same as or similar to the processor transitioning module 816, in accordance with the example embodiments. In accordance with at least some embodiments, the first threshold of the second reward system includes a threshold of the level threshold 363, such as the threshold of five tokens for Level 0.

Block 914 includes outputting, on the graphical user interface while the processor operates in the second operating state, one or more spins of the reel set for the second operating state. The functions of block 914 can be performed by one or more hardware processors configured by machine-readable instructions including a module that is the same as or similar to the spin outputting module 810, in accordance with the example embodiments. As an example, the second reel set can include and/or be configured like the reel set 451 shown in FIG. 3C.

Block 916 includes determining, by the processor based on the one or more spins of the reel set for the second operating state, a second running total of a number of times the particular symbol is displayed on the graphical user interface while the processor is operating in the second operating state. The functions of block 916 can be performed by one or more hardware processors configured by machine-readable instructions including a module that is the same as or similar to the total determination module 812, in accordance with the example embodiments. As an example, the processor can track the second running total within the token value 362 and can determine the second running total, at least in part, by reading the token value 362.

Block 918 includes determining, by the processor, whether the second running total exceeds one or more of a second threshold of the first reward system or a second threshold of the second reward system. The functions of block 918 can be performed by one or more hardware processors configured by machine-readable instructions including a module that is the same as or similar to total determination module 812, in accordance with the example embodiments. As an example, the processor can make this determination by comparing the token value 362 to the booster point value 359 and the level threshold 363 for the current level of the feature event.

Block 920 includes outputting, by the processor, at least one reward in response to the second running total exceeding one or more of the second threshold of the first reward system or the second threshold of the second reward system. The functions of block 920 can be performed by one or more hardware processors configured by machine-readable instructions including a module that is the same as or similar to reward outputting module 814, in accordance with the example embodiments. As an example, the processor can output a reward from one or more of the rewards (e.g., awards) discussed at block 622, 626, 628 shown in FIG. 6.

In at least some embodiments of a method including one or more functions of the set 900, a plurality of reel sets includes a first reel set and a second reel set. The first reel set includes one or more different reels than the second reel set. The different reels include different combinations of symbols. The one or more spins of the reel set for the first operating state include one or more spins of the first reel set after selection of the first reel set for the first operating state. The one or more spins of the reel set for the second operating state include one or more spins of the second reel set after selection of the second reel set for the second operating state.

Next, FIG. 9B illustrates additional functions of the set 900, in accordance with one or more implementations. In accordance with the example embodiments, a method based on the set 900 can include one or more functions of the set 900 shown in FIG. 9B.

Block 922 includes transitioning, in response to the second running total exceeding the second threshold of the second reward system, the processor from operating in the second operating state to a third operating state. The functions of block 922 can be performed by one or more hardware processors configured by machine-readable instructions including a module that is the same as or similar to processor transitioning module 816, in accordance with the example embodiments. In accordance with at least some embodiments, the second threshold of the second reward system includes a threshold of the level threshold 363, such as the threshold of ten tokens for Level 1.

Block 924 includes outputting, on the graphical user interface while the processor operates in the third operating state, one or more spins of the reel set for the third operating state. The functions of block 924 can be performed by one or more hardware processors configured by machine-readable instructions including a module that is the same as or similar to spin outputting module 810, in accordance with the example embodiments. As an example, the third reel set can include and/or be configured like the reel set 452 shown in FIG. 3C.

Block 926 includes determining, by the processor based on the one or more spins of the reel set for the third operating state, a third running total of a number of times the particular symbol is displayed on the graphical user interface while the processor is operating in the third operating state. The functions of block 926 can be performed by one or more hardware processors configured by machine-readable instructions including a module that is the same as or similar to total determination module 812, in accordance with the example embodiments. As an example, the processor can track the third running total within the token value 362 and can determine the third running total, at least in part, by reading the token value 362.

Block 928 includes determining, by the processor, whether the third running total exceeds one or more of a third threshold of the first reward system or a third threshold of the second reward system. The functions of block 928 can be performed by one or more hardware processors configured by machine-readable instructions including a module that is the same as or similar to total determination module 812, in accordance with the example embodiments. As an example, the processor can make this determination by comparing the token value 362 to the booster point value 359 and the level threshold 363 for the current level of the feature event.

Block 930 includes outputting, by the processor, at least one reward in response to the third running total exceeding one or more of the third threshold of the first reward system or the third threshold of the second reward system. The functions of block 930 can be performed by one or more hardware processors configured by machine-readable instructions including a module that is the same as or similar to reward outputting module 814, in accordance with the example embodiments. As an example, the processor can output a reward from one or more of the rewards (e.g., awards) discussed at block 622, 626, 628 shown in FIG. 6.

In at least some embodiments of a method including one or more functions of the set 900, a plurality of reel sets includes a first reel set, a second reel set, and a third reel set. Each of the first reel set, the second reel set, and the third reel set include one or more different reels compared to reels of other reel sets of the first reel set, the second reel set, and the third reel set. The different reels include different combinations of symbols. The one or more spins of the reel set for the first operating state include one or more spins of the first reel set after selection of the first reel set for the first operating state. The one or more spins of the reel set for the second operating state include one or more spins of the second reel set after selection of the second reel set for the second operating state. The one or more spins of the reel set for the third operating state include one or more spins of the third reel set after selection of the third reel set for the third operating state.

Next, FIG. 9C illustrates additional functions of the set 900, in accordance with one or more implementations. In accordance with the example embodiments, a method based on the set 900 can include one or more functions of the set 900 shown in FIG. 9C.

Block 932 includes transitioning, in response to the third running total exceeding the third threshold of the second reward system, the processor from operating in the third operating state to a fourth operating state. The functions of block 932 can be performed by one or more hardware processors configured by machine-readable instructions including a module that is the same as or similar to processor transitioning module 816, in accordance with the example embodiments. In accordance with at least some embodiments, the third threshold of the second reward system includes a threshold of the level threshold 363, such as the threshold of fifteen tokens for Level 2.

Block 934 includes outputting, on the graphical user interface while the processor operates in the fourth operating state, one or more spins of the reel set for the fourth operating state. The functions of block 934 can be performed by one or more hardware processors configured by machine-readable instructions including a module that is the same as or similar to spin outputting module 810, in accordance with the example embodiments. As an example, the fourth reel set can include and/or be configured like the reel set 453 shown in FIG. 3C.

Block 936 includes determining, by the processor based on the one or more spins of the reel set for the fourth operating state, a fourth running total of a number of times the particular symbol is displayed on the graphical user interface while the processor is operating in the fourth operating state. The functions of block 936 can be performed by one or more hardware processors configured by machine-readable instructions including a module that is the same as or similar to total determination module 812, in accordance with the example embodiments. As an example, the processor can track the fourth running total within the token value 362 and can determine the fourth running total, at least in part, by reading the token value 362

Block 938 includes determining, by the processor, whether the fourth running total exceeds one or more of a fourth threshold of the first reward system or a fourth threshold of the second reward system. The functions of block 938 can be performed by one or more hardware processors configured by machine-readable instructions including a module that is the same as or similar to total determination module 812, in accordance with the example embodiments. As an example, the processor can make this determination by comparing the token value 362 to the booster point value 359 and the level threshold 363 for the current level of the feature event.

Block 940 includes outputting, by the processor, at least one reward in response to the fourth running total exceeding one or more of the fourth threshold of the first reward system or the fourth threshold of the second reward system. The functions of block 940 can be performed by one or more hardware processors configured by machine-readable instructions including a module that is the same as or similar to reward outputting module 814, in accordance with the example embodiments. As an example, the processor can output a reward from one or more of the rewards (e.g., awards) discussed at block 622, 626, 628 shown in FIG. 6.

In at least some embodiments of a method including one or more functions of the set 900, a plurality of reel sets includes a first reel set, a second reel set, a third reel set, and a fourth reel set. Each of the first reel set, the second reel set, the third reel set, and the fourth reel set include one or more different reels compared to reels of other reel sets of the first reel set, the second reel set, the third reel set, and the fourth reel set. The different reels include different combinations of symbols. The one or more spins of the reel set for the first operating state include one or more spins of the first reel set after selection of the first reel set for the first operating state. The one or more spins of the reel set for the second operating state include one or more spins of the second reel set after selection of the second reel set for the second operating state. The one or more spins of the reel set for the third operating state include one or more spins of the third reel set after selection of the third reel set for the third operating state. The one or more spins of the reel set for the fourth operating state include one or more spins of the fourth reel set after selection of the fourth reel set for the fourth operating state.

Next, FIG. 9D illustrates an additional function of the set 900, in accordance with one or more implementations. In accordance with the example embodiments, a method based on the set 900 can include the function of the set 900 shown in FIG. 9D.

Block 942 includes transitioning the processor from a prior operating state to the first operating state. The functions of block 942 can be performed by one or more hardware processors configured by machine-readable instructions including a module that is the same as or similar to the processor transitioning module 816, in accordance with the example embodiments.

Next, FIG. 9E illustrates an additional function of the set 900, in accordance with one or more implementations. In accordance with the example embodiments, a method based on the set 900 can include the function of the set 900 shown in FIG. 9E.

Block 944 includes receiving, at an input device configured to input a payment amount, a first payment amount. The functions of block 944 can be performed by one or more hardware processors configured by machine-readable instructions including a module that is the same as or similar to the payment amount receiving module 818, in accordance with the example embodiments. In at least some embodiments, the input device includes the acceptor 107, 107a, 107b.

### IV. Conclusions

While one or more disclosed functions have been described as being performed by certain computing systems (e.g., the computing system 100, 100a, 100b, 800), one or more of the functions can be performed by any entity, including but not limited to those described herein. As such, while this disclosure includes examples in which the computing system 100a performs select functions and sends data to the computing system 100b, such that the computing system 100b can perform complementing functions and receive the data, variations to those functions can be made while adhering to the general server-client dichotomy and the scope of the disclosed machines, computing systems, and methods.

For example, rather than the computing system 100a sending select data (e.g., a symbol set, a spin meter value, a booster point value, a GUI, a current level value, or a token value) to the computing system 100b, such that the computing system 100b can generate and display appropriate images, the computing system 100a can generate the images and send them to the computing system 100b for display. Indeed, it will be appreciated by one of ordinary skill in the art that the “break point” between the server computing system's functions and the client computing system's functions can be varied.

Furthermore, the functions described throughout this can be performed in an order different than an order of functions (if any) described herein or shown in the drawings. Additionally, embodiments in the form of a method can include one or more of the functions described herein or shown in the drawings.

Furthermore still, while examples have been described in terms of select embodiments, alterations and permutations of these embodiments will be apparent to those of ordinary skill in the art. Other changes, substitutions, and alterations are also possible without departing from the disclosed machines, computing systems, and methods in their broader aspects as set forth in the claims below.

Finally, one or more embodiments described above may relate to one or more of the following enumerated example embodiments (EEEs).

EEE A1 is a computing system comprising: a processor; and a computer-readable memory storing executable instructions, wherein execution of the executable instructions by the processor causes the computing system to perform functions, the functions include: providing, by the processor, a graphical user interface comprising multiple symbol positions arranged in multiple rows and multiple columns, wherein: each column of the multiple columns is arranged to depict a spinnable reel of a reel set, each spinnable reel includes multiple different symbols from a set of symbols, and the set of symbols includes a particular symbol; outputting, on the graphical user interface while the processor operates in a first operating state, one or more spins of the reel set for the first operating state; determining, by the processor based on the one or more spins of the reel set for the first operating state, a first running total of a number of times the particular symbol is displayed on the graphical user interface while the processor is operating in the first operating state; determining, by the processor, whether the first running total exceeds one or more of a first threshold of a first reward system or a first threshold of a second reward system; outputting, by the processor, at least one reward in response to the first running total exceeding one or more of the first threshold of the first reward system or the first threshold of the second reward system; transitioning, in response to the first running total exceeding the first threshold of the second reward system, the processor from operating in the first operating state to a second operating state; outputting, on the graphical user interface while the processor operates in the second operating state, one or more spins of the reel set for the second operating state; determining, by the processor based on the one or more spins of the reel set for the second operating state, a second running total of a number of times the particular symbol is displayed on the graphical user interface while the processor is operating in the second operating state; determining, by the processor, whether the second running total exceeds one or more of a second threshold of the first reward system or a second threshold of the second reward system; and outputting, by the processor, at least one reward in response to the second running total exceeding one or more of the second threshold of the first reward system or the second threshold of the second reward system.

EEE A2 is the computing system of EEE A1, wherein the functions further include transitioning, in response to the second running total exceeding the second threshold of the second reward system, the processor from operating in the second operating state to a third operating state; outputting, on the graphical user interface while the processor operates in the third operating state, one or more spins of the reel set for the third operating state; determining, by the processor based on the one or more spins of the reel set for the third operating state, a third running total of a number of times the particular symbol is displayed on the graphical user interface while the processor is operating in the third operating state; determining, by the processor, whether the third running total exceeds one or more of a third threshold of the first reward system or a third threshold of the second reward system; outputting, by the processor, at least one reward in response to the third running total exceeding one or more of the third threshold of the first reward system or the third threshold of the second reward system.

EEE A3 is the computing system of EEE A2, wherein the third threshold of the second reward system is greater than the second threshold of the second reward system; and wherein the second threshold of the second reward system is greater than the first threshold of the second reward system.

EEE A4 is the computing system according to any one of EEE A2 or A3, wherein: a plurality of reel sets includes a first reel set, a second reel set, and a third reel set, each of the first reel set, the second reel set, and the third reel set include one or more different reels compared to reels of other reel sets of the first reel set, the second reel set, and the third reel set, the different reels include different combinations of symbols, the one or more spins of the reel set for the first operating state include one or more spins of the first reel set after selection of the first reel set for the first operating state, the one or more spins of the reel set for the second operating state include one or more spins of the second reel set after selection of the second reel set for the second operating state, and the one or more spins of the reel set for the third operating state include one or more spins of the third reel set after selection of the third reel set for the third operating state.

EEE A5 is the computing system according to any one of EEE A2 or A3, wherein the functions further include: transitioning, in response to the third running total exceeding the third threshold of the second reward system, the processor from operating in the third operating state to a fourth operating state; outputting, on the graphical user interface while the processor operates in the fourth operating state, one or more spins of the reel set for the fourth operating state; determining, by the processor based on the one or more spins of the reel set for the fourth operating state, a fourth running total of a number of times the particular symbol is displayed on the graphical user interface while the processor is operating in the fourth operating state; determining, by the processor, whether the fourth running total exceeds one or more of a fourth threshold of the first reward system or a fourth threshold of the second reward system; outputting, by the processor, at least one reward in response to the fourth running total exceeding one or more of the fourth threshold of the first reward system or the fourth threshold of the second reward system.

EEE A6 is the computing system of EEE A5, wherein the fourth threshold of the second reward system is greater than the third threshold of the second reward system; wherein the third threshold of the second reward system is greater than the second threshold of the second reward system; and wherein the second threshold of the second reward system is greater than the first threshold of the second reward system.

EEE A7 is the computing system according to any one of EEE A5 to A6, wherein: a plurality of reel sets includes a first reel set, a second reel set, a third reel set, and a fourth reel set, each of the first reel set, the second reel set, the third reel set, and the fourth reel set include one or more different reels compared to reels of other reel sets of the first reel set, the second reel set, the third reel set, and the fourth reel set, the different reels include different combinations of symbols, the one or more spins of the reel set for the first operating state include one or more spins of the first reel set after selection of the first reel set for the first operating state, the one or more spins of the reel set for the second operating state include one or more spins of the second reel set after selection of the second reel set for the second operating state, the one or more spins of the reel set for the third operating state include one or more spins of the third reel set after selection of the third reel set for the third operating state, and the one or more spins of the reel set for the fourth operating state include one or more spins of the fourth reel set after selection of the fourth reel set for the fourth operating state.

EEE A8 is the computing system of EEE A1, wherein: a plurality of reel sets includes a first reel set and a second reel set, the first reel set includes one or more different reels than the second reel set, the different reels include different combinations of symbols, the one or more spins of the reel set for the first operating state include one or more spins of the first reel set after selection of the first reel set for the first operating state, and the one or more spins of the reel set for the second operating state include one or more spins of the second reel set after selection of the second reel set for the second operating state

EEE A9 is the computing system according to any one of EEE A1 to A8, wherein the functions further include transitioning the processor from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; wherein the trigger condition includes a particular combination of symbols from the set of symbols appearing within a particular pattern of the graphical user interface; and wherein the particular pattern includes a particular payline of the multiple particular patterns.

EEE A10 is the computing system according to any one of EEE A1 to A8, wherein the functions further include transitioning the processor from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; wherein the trigger condition includes a particular combination of symbols from the set of symbols appearing within a particular pattern of the graphical user interface; and wherein the particular pattern includes a particular payway of the multiple particular patterns.

EEE A11 is the computing system according to any one of EEE A9 or A10, wherein each of the multiple particular patterns includes a horizontally extending pattern, a vertically extending pattern, a diagonally extending pattern, an angled pattern, a circular pattern, or a combination thereof.

EEE A12 is the computing system according to any one of EEE A1 to A8, wherein the processor is transitioned from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; and wherein the trigger condition includes a landing of multiple special symbols within the multiple symbol positions.

EEE A13 is the computing system according to any one of EEE A9 to A12, wherein each particular pattern comprises three symbol positions across consecutive columns of the multiple columns.

EEE A14 is the computing system according to any one of EEE A9 to A12, wherein each pattern comprises three or more symbol positions across consecutive columns of the multiple columns.

EEE A15 is the computing system according to any one of EEE A13 or A14, wherein each pattern includes a symbol position in a left-most column of the multiple columns.

EEE A16 is the computing system according to any one of EEE A13 or A14, wherein each pattern includes a symbol position in a right-most column of the multiple columns.

EEE A17 is the computing system according to any one of EEE A1 to A16, wherein the functions further include receiving, at an input device configured to input a payment amount, a first payment amount; wherein the processor is transitioned to a prior operating state in response to receiving the first payment amount.

EEE A18 is the computing system of EEE A17, wherein the input device includes an acceptor.

EEE A19 is the computing system of EEE A18, wherein the acceptor includes a paper money acceptor, a coin acceptor, a token acceptor, a validator, and/or a card reader.

EEE A20 is the computing system according to any one of EEE A17 to A19, wherein the input device includes a user-selectable control on a touch-sensitive screen of a display.

EEE A21 is the computing system according to any one of EEE A16 to A20, wherein the multiple special symbols function as scatter symbols.

EEE A22 is the computing system of EEE A21, wherein the scatter symbols effectuate a trigger event irrespective of positions of the scatter symbols among the multiple symbol positions.

EEE A23 is the computing system according to any one of EEE A16 to A22, wherein the multiple special symbols includes three or more special symbols.

EEE A24 is the computing system according to any one of EEE A16 to A23, wherein each special symbol of the multiple special symbols is identical in appearance to each other special symbol of the multiple special symbols.

EEE A25 is the computing system according to any one of EEE A1 to A24, wherein transitioning the processor from operating in the first operating state to the second operating state includes selecting the second reel set to use instead of the first reel set; wherein transitioning the processor from operating in the first operating state to the second operating state includes incrementing a spins counter by a predetermined number of spins; wherein transitioning the processor from operating in the first operating state to the second operating state includes outputting, on the graphical user interface, an icon indicating a quantity of spins indicated by the spins counter; and wherein transitioning the processor from operating in the first operating state to the second operating state includes activating a user selectable control selectable to initiate a next spin of spinnable reels in the multiple columns.

EEE A26 is the computing system of EEE A25, wherein providing the graphical user interface includes providing the graphical user interface on a touch display screen; and wherein the user selectable control selectable to initiate the next spin includes a user selectable control displayed on the touch display screen.

EEE A27 is the computing system of EEE A25, wherein providing the graphical user interface includes providing the graphical user interface on a display screen; and wherein the user selectable control selectable to initiate the next spin includes a user interface component remote from the display screen and operatively coupled to the processor.

EEE A28 is the computing system according to any one of EEE A1 to A27, wherein the second reward system includes multiple levels; wherein each level of the second reward system corresponds to a different reel set of the plurality of reel sets; and wherein the processor transitions to a different operating state for use with each different reel set of the plurality of reel sets.

EEE A29 is the computing system of EEE A28, wherein the multiple levels are ordered in a sequence beginning at a lowest level and ending at a greatest level.

EEE A30 is the computing system of EEE A29, wherein the multiple levels include one or more intermediary levels within the ordered sequence.

EEE A31 is the computing system of EEE A30, wherein a reward corresponding to reaching each level of the multiple levels of the second reward system includes a predetermined number of spins.

EEE A32 is the computing system of EEE A31, wherein a remaining number of spins is reset to the predetermined number of spins at each level of the second reward system.

EEE A33 is the computing system of EEE A32, wherein a remaining number of spins at each level of the second reward system is equal to the predetermined number of spins plus any free spins remaining in a previous level of the second reward system.

EEE A34 is the computing system according to any one of EEE A32 to A33, wherein the predetermined number of spins at each level of the second reward system is different for two or more levels of the second reward system.

EEE A35 is the computing system according to any one of EEE A1 to A34, wherein the graphical user interface comprises multiple particular patterns, and wherein each particular pattern comprises multiple symbol positions across the multiple columns; wherein the processor determines for each particular pattern and each spin of the reels of the first reel set and each spin of the reels of the second reel set whether symbols in the symbol positions of the particular pattern form a winning pattern; and wherein the processor outputs a reward for the winning pattern.

EEE A36 is the computing system according to any one of EEE A1 to A35, wherein a reward associated with the first reward system provides a level upgrade in the second reward system.

EEE A37 is the computing system according to any one of EEE A1 to A36, wherein a reward associated with the first reward system is randomly chosen and/or modified from a predetermined list of available rewards corresponding to the first reward system.

EEE A38 is the computing system of EEE A37, wherein the predetermined list of available rewards corresponding to the first reward system includes one or more of additional free spins, additional collected special symbols, or activation of a special reward.

EEE A39 is the computing system according to any one of EEE A1 to A38, wherein the multiple rows include at least three rows.

EEE A40 is the computing system according to any one of EEE A1 to A39, wherein the multiple columns include at least three columns.

EEE A41 is the computing system according to any one of EEE A1 to A40, wherein the multiple columns include at least five columns, and wherein the multiple rows include at least three rows.

EEE A42 is the computing system according to any one of EEE A1 to A41, wherein a global symbol group stored in the computer-readable memory includes a plurality of symbols, subsets of which are displayable in a respective column of the multiple columns.

EEE A43 is the computing system of EEE A42, wherein a first plurality of symbols is randomly determined from the global symbol group; and wherein each of the first plurality of symbols is associated with one of the multiple symbol positions.

EEE A44 is the computing system according to any one of EEE A1 to A43, wherein the functions further include determining the second running total is less than the second threshold of the second reward system and a number of remaining spins in a spins counter for the second operating state is zero and then transitioning the processor to a next operating state; wherein the graphical user interface outputs an indication the processor is operating in the next operating state; and wherein a payment must be received while the processor operates in the next operating state before the processor transitions back to an operating state in which the processor is configured to output a reward based on spinning the reels.

EEE A45 is the computing system according to any one of EEE A1 to A44, wherein the second reward system includes multiple different levels; wherein the functions further include outputting, by the graphical user interface while the processor operates in the first operating state, a level display that indicates a first level of the second reward system is a current level of the second reward system in use by the processor; and wherein the functions further include outputting, by the graphical user interface while the processor operates in the second operating state, the level display that indicates a second level of the second reward system is the current level of the second reward system in use by the processor.

EEE A46 is the computing system of EEE A45, wherein the multiple levels are ordered in a sequence beginning at a lowest level and ending at a greatest level.

EEE A47 is the computing system of EEE A46, wherein the current level of the second reward system is the lowest level.

EEE A48 is the computing system of EEE A46, wherein the current level of the second reward system is the greatest level.

EEE A49 is the computing system of EEE A46, wherein the multiple levels include one or more intermediary levels within the ordered sequence.

EEE A50 is the computing system of EEE A49, wherein the current level of the second reward system is an intermediary level.

EEE A51 is the computing system of according to any one of EEE A45 to A50, wherein a primary reward is associated with each level of the multiple different levels of the second reward system.

EEE A52 is the computing system of EEE A51, wherein the primary reward associated with each level of the second reward system is different for different levels of the multiple levels of the second reward system.

EEE A53 is the computing system according to any one of EEE A51 to A52, wherein the primary award includes an award based on a payment amount entered using the computing system and a multiplier value.

EEE A54 is the computing system according to any one of EEE A1 to A53, wherein the computer-readable memory includes one or more from among: a spin meter value, a booster point value, a current level value, a token value, or a level threshold.

EEE A55 is the computing system according to any one of EEE A1 to A54, wherein transitioning the processor between two different operating states includes one or more from among: selecting a next reel set among the multiple reel sets, resetting a booster point value stored in the computer-readable memory, resetting a spin meter value stored in the computer-readable memory, resetting a token value stored in the computer-readable memory, selecting a next level threshold from among multiple level thresholds, changing a current level value stored in the computer-readable memory, or changing a current level display on the graphical user interface to indicate a level corresponding to the operating state to which the processor transitioned.

EEE A56 is the computing system according to any one of EEE A1 to A55, wherein the functions further include terminating an event that provides awards using the first reward system and the second reward system in response to determining a greatest level of the second reward system has been reached.

EEE A57 is the computing system according to any one of EEE A1 to A56, wherein the functions further include outputting a particular audible sound to indicate transitioning the processor from operating in the first operating state to the second operating state.

EEE A58 is the computing system according to any one of EEE A2 to A56, wherein the functions further include outputting a particular audible sound to indicate transitioning the processor from operating in the first operating state to the second operating state, and transitioning the processor from operating in the second operating state to the third operating state.

EEE A59 is the computing system according to any one of EEE A4 to A56, wherein the functions further include outputting a particular audible sound to indicate transitioning the processor from operating in the first operating state to the second operating state, transitioning the processor from operating in the second operating state to the third operating state, and transitioning the processor from operating in the third operating state to the fourth operating state.

EEE A60 is the computing system according to any one of EEE A1 to A59, wherein the functions further include outputting, by the graphical user interface, an indication of one or more from among: the processor changing operating states, a number of remaining free spins, a current level, a quantity of tokens needed to achieve a next level, a quantity of tokens needed to achieve a next booster point, a quantity of tokens received towards achieving the next level, a quantity of tokens received towards achieving the booster point, terminating an event that provides awards using the first reward system and the second reward system, or receiving an award.

EEE B1 is a method comprising: providing, by a processor, a graphical user interface comprising multiple symbol positions arranged in multiple rows and multiple columns, wherein each column of the multiple columns arranged to depict a spinnable reel of a reel set, each spinnable reel includes multiple different symbols from a set of symbols, and the set of symbols includes a particular symbol; outputting, on the graphical user interface while the processor operates in a first operating state, one or more spins of the reel set for the first operating state; determining, by the processor based on the one or more spins of the reel set for the first operating state, a first running total of a number of times the particular symbol is displayed on the graphical user interface while the processor is operating in the first operating state; determining, by the processor, whether the first running total exceeds one or more of a first threshold of a first reward system or a first threshold of a second reward system; outputting, by the processor, at least one reward in response to the first running total exceeding one or more of the first threshold of the first reward system or the first threshold of the second reward system; transitioning, in response to the first running total exceeding the first threshold of the second reward system, the processor from operating in the first operating state to a second operating state; outputting, on the graphical user interface while the processor operates in the second operating state, one or more spins of the reel set for the second operating state; determining, by the processor based on the one or more spins of the reel set for the second operating state, a second running total of a number of times the particular symbol is displayed on the graphical user interface while the processor is operating in the second operating state; determining, by the processor, whether the second running total exceeds one or more of a second threshold of the first reward system or a second threshold of the second reward system; and outputting, by the processor, at least one reward in response to the second running total exceeding one or more of the second threshold of the first reward system or the second threshold of the second reward system.

EEE B2 is the method of EEE B1, further comprising: transitioning, in response to the second running total exceeding the second threshold of the second reward system, the processor from operating in the second operating state to a third operating state; outputting, on the graphical user interface while the processor operates in the third operating state, one or more spins of the reel set for the third operating state; determining, by the processor based on the one or more spins of the reel set for the third operating state, a third running total of a number of times the particular symbol is displayed on the graphical user interface while the processor is operating in the third operating state; determining, by the processor, whether the third running total exceeds one or more of a third threshold of the first reward system or a third threshold of the second reward system; and outputting, by the processor, at least one reward in response to the third running total exceeding one or more of the third threshold of the first reward system or the third threshold of the second reward system.

EEE B3 is the method of EEE B2, wherein the third threshold of the second reward system is greater than the second threshold of the second reward system; and wherein the second threshold of the second reward system is greater than the first threshold of the second reward system.

EEE B4 is the method according to any one of B2 or B3, wherein: a plurality of reel sets includes a first reel set, a second reel set, and a third reel set, each of the first reel set, the second reel set, and the third reel set include one or more different reels compared to reels of other reel sets of the first reel set, the second reel set, and the third reel set, the different reels include different combinations of symbols, the one or more spins of the reel set for the first operating state include one or more spins of the first reel set after selection of the first reel set for the first operating state, the one or more spins of the reel set for the second operating state include one or more spins of the second reel set after selection of the second reel set for the second operating state, and the one or more spins of the reel set for the third operating state include one or more spins of the third reel set after selection of the third reel set for the third operating state.

EEE B5 is the method according to any one of EEE B2 or B3, further comprising: transitioning, in response to the third running total exceeding the third threshold of the second reward system, the processor from operating in the third operating state to a fourth operating state; outputting, on the graphical user interface while the processor operates in the fourth operating state, one or more spins of the reel set for the fourth operating state; determining, by the processor based on the one or more spins of the reel set for the fourth operating state, a fourth running total of a number of times the particular symbol is displayed on the graphical user interface while the processor is operating in the fourth operating state; determining, by the processor, whether the fourth running total exceeds one or more of a fourth threshold of the first reward system or a fourth threshold of the second reward system; and outputting, by the processor, at least one reward in response to the fourth running total exceeding one or more of the fourth threshold of the first reward system or the fourth threshold of the second reward system.

EEE B6 is the method of EEE B5, wherein the fourth threshold of the second reward system is greater than the third threshold of the second reward system; wherein the third threshold of the second reward system is greater than the second threshold of the second reward system; and wherein the second threshold of the second reward system is greater than the first threshold of the second reward system.

EEE B7 is the method according to any one of EEE B5 or B6, wherein: a plurality of reel sets includes a first reel set, a second reel set, a third reel set, and a fourth reel set, each of the first reel set, the second reel set, the third reel set, and the fourth reel set include one or more different reels compared to reels of other reel sets of the first reel set, the second reel set, the third reel set, and the fourth reel set, the different reels include different combinations of symbols, the one or more spins of the reel set for the first operating state include one or more spins of the first reel set after selection of the first reel set for the first operating state, the one or more spins of the reel set for the second operating state include one or more spins of the second reel set after selection of the second reel set for the second operating state, the one or more spins of the reel set for the third operating state include one or more spins of the third reel set after selection of the third reel set for the third operating state, and the one or more spins of the reel set for the fourth operating state include one or more spins of the fourth reel set after selection of the fourth reel set for the fourth operating state.

EEE B8 is the method of EEE B1, wherein: a plurality of reel sets includes a first reel set and a second reel set, the first reel set includes one or more different reels than the second reel set, the different reels include different combinations of symbols, the one or more spins of the reel set for the first operating state include one or more spins of the first reel set after selection of the first reel set for the first operating state, and the one or more spins of the reel set for the second operating state include one or more spins of the second reel set after selection of the second reel set for the second operating state.

EEE B9 is the method according to any one of EEE B1 to B8, further comprising: transitioning the processor from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; wherein the trigger condition includes a particular combination of symbols from the set of symbols appearing within a particular pattern of the graphical user interface; and wherein the particular pattern includes a particular payline of the multiple particular patterns.

EEE B10 is the method according to any one of EEE B1 to B8, wherein the functions further include transitioning the processor from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; wherein the trigger condition includes a particular combination of symbols from the set of symbols appearing within a particular pattern of the graphical user interface; and wherein the particular pattern includes a particular payway of the multiple particular patterns.

EEE B11 is the method according to any one of EEE B9 or B10, wherein each of the multiple particular patterns includes a horizontally extending pattern, a vertically extending pattern, a diagonally extending pattern, an angled pattern, a circular pattern, or a combination thereof.

EEE B12 is the method according to any one of EEE B1 to B8, wherein the processor is transitioned from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; and wherein the trigger condition includes a landing of multiple special symbols within the multiple symbol positions.

EEE B13 is the method according to any one of EEE B9 to B12, wherein each particular pattern comprises three symbol positions across consecutive columns of the multiple columns.

EEE B14 is the method according to any one of EEE B9 to B12, wherein each pattern comprises three or more symbol positions across consecutive columns of the multiple columns.

EEE B15 is the method according to any one of EEE B13 or B14, wherein each pattern includes a symbol position in a left-most column of the multiple columns.

EEE B16 is the method according to any one of EEE B13 or B14, wherein each pattern includes a symbol position in a right-most column of the multiple columns.

EEE B17 is the method according to any one of EEE B1 to B16, further comprising: receiving, at an input device configured to input a payment amount, a first payment amount; wherein the processor is transitioned to a prior operating state in response to receiving the first payment amount.

EEE B18 is the method of EEE B17, wherein the input device includes an acceptor.

EEE B19 is the method of EEE B18, wherein the acceptor includes a paper money acceptor, a coin acceptor, a token acceptor, a validator, and/or a card reader.

EEE B20 is the method according to any one of EEE B17 to B19, wherein the input device includes a user-selectable control on a touch-sensitive screen of a display.

EEE B21 is the method according to any one of EEE B16 to B20, wherein the multiple special symbols function as scatter symbols.

EEE B22 is the method of EEE B21, wherein the scatter symbols effectuate a trigger event irrespective of positions of the scatter symbols among the multiple symbol positions.

EEE B23 is the method according to any one of EEE B16 to B22, wherein the multiple special symbols includes three or more special symbols.

EEE B24 is the method according to any one of EEE B16 to B23, wherein each special symbol of the multiple special symbols is identical in appearance to each other special symbol of the multiple special symbols.

EEE B25 is the method according to any one of EEE B1 to B24, wherein transitioning the processor from operating in the first operating state to the second operating state includes selecting the second reel set to use instead of the first reel set; wherein transitioning the processor from operating in the first operating state to the second operating state includes incrementing a spins counter by a predetermined number of spins; wherein transitioning the processor from operating in the first operating state to the second operating state includes outputting, on the graphical user interface, an icon indicating a quantity of spins indicated by the spins counter; and wherein transitioning the processor from operating in the first operating state to the second operating state includes activating a user selectable control selectable to initiate a next spin of spinnable reels in the multiple columns.

EEE B26 is the method of EEE B25, wherein providing the graphical user interface includes providing the graphical user interface on a touch display screen; and wherein the user selectable control selectable to initiate the next spin includes a user selectable control displayed on the touch display screen.

EEE B27 is the method of EEE B25, wherein providing the graphical user interface includes providing the graphical user interface on a display screen; and wherein the user selectable control selectable to initiate the next spin includes a user interface component remote from the display screen and operatively coupled to the processor.

EEE B28 is the method according to any one of EEE B1 to B27, wherein the second reward system includes multiple levels; wherein each level of the second reward system corresponds to a different reel set of the plurality of reel sets; and wherein the processor transitions to a different operating state for use with each different reel set of the plurality of reel sets.

EEE B29 is the method of EEE B28, wherein the multiple levels are ordered in a sequence beginning at a lowest level and ending at a greatest level.

EEE B30 is the method of EEE B29, wherein the multiple levels include one or more intermediary levels within the ordered sequence.

EEE B31 is the method of EEE B30, wherein a reward corresponding to reaching each level of the multiple levels of the second reward system includes a predetermined number of spins.

EEE B32 is the method of EEE B31, wherein a remaining number of spins is reset to the predetermined number of spins at each level of the second reward system.

EEE B33 is the method of EEE B32, wherein a remaining number of spins at each level of the second reward system is equal to the predetermined number of spins plus any free spins remaining in a previous level of the second reward system.

EEE B34 is the method according to any one of EEE B32 to B33, wherein the predetermined number of spins at each level of the second reward system is different for two or more levels of the second reward system.

EEE B35 is the method according to any one of EEE B1 to B34, wherein the graphical user interface comprises multiple particular patterns, and wherein each particular pattern comprises multiple symbol positions across the multiple columns; wherein the processor determines for each particular pattern and each spin of the reels of the first reel set and each spin of the reels of the second reel set whether symbols in the symbol positions of the particular pattern form a winning pattern; and wherein the processor outputs a reward for the winning pattern.

EEE B36 is the method according to any one of EEE B1 to B35, wherein a reward associated with the first reward system provides a level upgrade in the second reward system.

EEE B37 is the method according to any one of EEE B1 to B36, wherein a reward associated with the first reward system is randomly chosen and/or modified from a predetermined list of available rewards corresponding to the first reward system.

EEE B38 is the method of EEE B37, wherein the predetermined list of available rewards corresponding to the first reward system includes one or more of additional free spins, additional collected special symbols, or activation of a special reward.

EEE B39 is the method according to any one of EEE B1 to B38, wherein the multiple rows include at least three rows.

EEE B40 is the method according to any one of EEE B1 to B39, wherein the multiple columns include at least three columns.

EEE B41 is the method according to any one of EEE B1 to B40, wherein the multiple columns include at least five columns, and wherein the multiple rows include at least three rows.

EEE B42 is the method according to any one of EEE B1 to B41, wherein a global symbol group stored in a computer-readable memory includes a plurality of symbols, subsets of which are displayable in a respective column of the multiple columns.

EEE B43 is the method according to any one of EEE B1 to B42, wherein a first plurality of symbols is randomly determined from the global symbol group; and wherein each of the first plurality of symbols is associated with one of the multiple symbol positions.

EEE B44 is the method according to any one of EEE B1 to B43, wherein the method further includes determining the second running total is less than the second threshold of the second reward system and a number of remaining spins in a spins counter for the second operating state is zero and then transitioning the processor to a next operating state; wherein the graphical user interface outputs an indication the processor is operating in the next operating state; and wherein a payment must be received while the processor operates in the next operating state before the processor transitions back to an operating state in which the processor is configured to output a reward based on spinning the reels.

EEE B45 is the method according to any one of EEE B1 to B44, wherein the second reward system includes multiple different levels; wherein the method further includes outputting, by the graphical user interface while the processor operates in the first operating state, a level display that indicates a first level of the second reward system is a current level of the second reward system in use by the processor, and outputting, by the graphical user interface while the processor operates in the second operating state, the level display that indicates a second level of the second reward system is the current level of the second reward system in use by the processor.

EEE B46 is the method of EEE B45, wherein the multiple levels are ordered in a sequence beginning at a lowest level and ending at a greatest level.

EEE B47 is the method of EEE B46, wherein the current level of the second reward system is the lowest level.

EEE B48 is the method of EEE B46, wherein the current level of the second reward system is the greatest level.

EEE B49 is the method of EEE B46, wherein the multiple levels include one or more intermediary levels within the ordered sequence.

EEE B50 is the method of EEE B49, wherein the current level of the second reward system is an intermediary level.

EEE B51 is the method according to any one of EEE B45 to B50, wherein a primary reward is associated with each level of the multiple different levels of the second reward system.

EEE B52 is the method of EEE B51, wherein the primary reward associated with each level of the second reward system is different for different levels of the multiple levels of the second reward system.

EEE B53 is the method according to any one of EEE B51 to B52, wherein the primary award includes an award based on a payment amount entered using an acceptor and a multiplier value.

EEE B54 is the method according to any one of EEE B1 to B53, wherein a computer-readable medium includes one or more from among: a spin meter value, a booster point value, a current level value, a token value, or a level threshold.

EEE B55 is the method according to any one of EEE B1 to B54, wherein transitioning the processor between two different operating states includes one or more from among: selecting a next reel set among the multiple reel sets, resetting a booster point value stored in a computer-readable medium, resetting a spin meter value stored in the computer-readable medium, resetting a token value stored in the computer-readable medium, selecting a next level threshold from among multiple level thresholds, changing a current level value stored in the computer-readable medium, or changing a current level display on the graphical user interface to indicate a level corresponding to the operating state to which the processor transitioned.

EEE B56 is the method according to any one of EEE B1 to B55, wherein the functions further include terminating an event that provides awards using the first reward system and the second reward system in response to determining a greatest level of the second reward system has been reached.

EEE B57 is the method according to any one of EEE B1 to B56, wherein the functions further include outputting a particular audible sound to indicate transitioning the processor from operating in the first operating state to the second operating state.

EEE B58 is the method according to any one of EEE B2 to B56, wherein the functions further include outputting a particular audible sound to indicate transitioning the processor from operating in the first operating state to the second operating state, and transitioning the processor from operating in the second operating state to the third operating state.

EEE B59 is the method according to any one of EEE B4 to B56, wherein the functions further include outputting a particular audible sound to indicate transitioning the processor from operating in the first operating state to the second operating state, transitioning the processor from operating in the second operating state to the third operating state, and transitioning the processor from operating in the third operating state to the fourth operating state.

EEE B60 is the method according to any one of EEE B1 to B59, wherein the functions further include outputting, by the graphical user interface, an indication of one or more from among: the processor changing operating states, a number of remaining free spins, a current level, a quantity of tokens needed to achieve a next level, a quantity of tokens needed to achieve a next booster point, a quantity of tokens received towards achieving the next level, a quantity of tokens received towards achieving the booster point, terminating an event that provides awards using the first reward system and the second reward system, or receiving an award.

EEE C1 is a computer-readable memory having stored therein instructions executable by a processor to cause a computing system to perform functions comprising: providing, by the processor, a graphical user interface comprising multiple symbol positions arranged in multiple rows and multiple columns, wherein: each column of the multiple columns is arranged to depict a spinnable reel of a reel set, each spinnable reel includes multiple different symbols from a set of symbols, and the set of symbols includes a particular symbol; outputting, on the graphical user interface while the processor operates in a first operating state, one or more spins of the reel set for the first operating state; determining, by the processor based on the one or more spins of the reel set for the first operating state, a first running total of a number of times the particular symbol is displayed on the graphical user interface while the processor is operating in the first operating state; determining, by the processor, whether the first running total exceeds one or more of a first threshold of a first reward system or a first threshold of a second reward system; outputting, by the processor, at least one reward in response to the first running total exceeding one or more of the first threshold of the first reward system or the first threshold of the second reward system; transitioning, in response to the first running total exceeding the first threshold of the second reward system, the processor from operating in the first operating state to a second operating state; outputting, on the graphical user interface while the processor operates in the second operating state, one or more spins of the reel set for the second operating state; determining, by the processor based on the one or more spins of the reel set for the second operating state, a second running total of a number of times the particular symbol is displayed on the graphical user interface while the processor is operating in the second operating state; determining, by the processor, whether the second running total exceeds one or more of a second threshold of the first reward system or a second threshold of the second reward system; and outputting, by the processor, at least one reward in response to the second running total exceeding one or more of the second threshold of the first reward system or the second threshold of the second reward system.

EEE C2 is the computer-readable memory of EEE C1, wherein the functions further comprise: transitioning, in response to the second running total exceeding the second threshold of the second reward system, the processor from operating in the second operating state to a third operating state; outputting, on the graphical user interface while the processor operates in the third operating state, one or more spins of the reel set for the third operating state; determining, by the processor based on the one or more spins of the reel set for the third operating state, a third running total of a number of times the particular symbol is displayed on the graphical user interface while the processor is operating in the third operating state; determining, by the processor, whether the third running total exceeds one or more of a third threshold of the first reward system or a third threshold of the second reward system; and outputting, by the processor, at least one reward in response to the third running total exceeding one or more of the third threshold of the first reward system or the third threshold of the second reward system.

EEE C3 is the computer-readable memory of EEE C2, wherein the third threshold of the second reward system is greater than the second threshold of the second reward system; and wherein the second threshold of the second reward system is greater than the first threshold of the second reward system.

EEE C4 is the computer-readable memory according to any one of C2 or C3, wherein: a plurality of reel sets includes a first reel set, a second reel set, and a third reel set, each of the first reel set, the second reel set, and the third reel set include one or more different reels compared to reels of other reel sets of the first reel set, the second reel set, and the third reel set, the different reels include different combinations of symbols, the one or more spins of the reel set for the first operating state include one or more spins of the first reel set after selection of the first reel set for the first operating state, the one or more spins of the reel set for the second operating state include one or more spins of the second reel set after selection of the second reel set for the second operating state, and the one or more spins of the reel set for the third operating state include one or more spins of the third reel set after selection of the third reel set for the third operating state.

EEE C5 is the computer-readable memory according to any one of EEE C2 or C3, wherein the functions further comprise: transitioning, in response to the third running total exceeding the third threshold of the second reward system, the processor from operating in the third operating state to a fourth operating state; outputting, on the graphical user interface while the processor operates in the fourth operating state, one or more spins of the reel set for the fourth operating state; determining, by the processor based on the one or more spins of the reel set for the fourth operating state, a fourth running total of a number of times the particular symbol is displayed on the graphical user interface while the processor is operating in the fourth operating state; determining, by the processor, whether the fourth running total exceeds one or more of a fourth threshold of the first reward system or a fourth threshold of the second reward system; and outputting, by the processor, at least one reward in response to the fourth running total exceeding one or more of the fourth threshold of the first reward system or the fourth threshold of the second reward system.

EEE C6 is the computer-readable memory of EEE C5, wherein the fourth threshold of the second reward system is greater than the third threshold of the second reward system; wherein the third threshold of the second reward system is greater than the second threshold of the second reward system; and wherein the second threshold of the second reward system is greater than the first threshold of the second reward system.

EEE C7 is the computer-readable memory according to any one of EEE C5 or C6, wherein: a plurality of reel sets includes a first reel set, a second reel set, a third reel set, and a fourth reel set, each of the first reel set, the second reel set, the third reel set, and the fourth reel set include one or more different reels compared to reels of other reel sets of the first reel set, the second reel set, the third reel set, and the fourth reel set, the different reels include different combinations of symbols, the one or more spins of the reel set for the first operating state include one or more spins of the first reel set after selection of the first reel set for the first operating state, the one or more spins of the reel set for the second operating state include one or more spins of the second reel set after selection of the second reel set for the second operating state, the one or more spins of the reel set for the third operating state include one or more spins of the third reel set after selection of the third reel set for the third operating state, and the one or more spins of the reel set for the fourth operating state include one or more spins of the fourth reel set after selection of the fourth reel set for the fourth operating state.

EEE C8 is the computer-readable memory of EEE C1, wherein: a plurality of reel sets includes a first reel set and a second reel set, the first reel set includes one or more different reels than the second reel set, the different reels include different combinations of symbols, the one or more spins of the reel set for the first operating state include one or more spins of the first reel set after selection of the first reel set for the first operating state, and the one or more spins of the reel set for the second operating state include one or more spins of the second reel set after selection of the second reel set for the second operating state.

EEE C9 is the computer-readable memory according to any one of EEE C1 to C8, wherein the functions further comprise: transitioning the processor from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; wherein the trigger condition includes a particular combination of symbols from the set of symbols appearing within a particular pattern of the graphical user interface; and wherein the particular pattern includes a particular payline of the multiple particular patterns.

EEE C10 is the computer-readable memory according to any one of EEE C1 to C8, wherein the functions further comprising transitioning the processor from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; wherein the trigger condition includes a particular combination of symbols from the set of symbols appearing within a particular pattern of the graphical user interface; and wherein the particular pattern includes a particular payway of the multiple particular patterns.

EEE C11 is the computer-readable memory according to any one of EEE C9 or C10, wherein each of the multiple particular patterns includes a horizontally extending pattern, a vertically extending pattern, a diagonally extending pattern, an angled pattern, a circular pattern, or a combination thereof.

EEE C12 is the computer-readable memory according to any one of EEE C1 to C8, wherein the processor is transitioned from a prior operating state to the first operating state; wherein transitioning from the prior operating state to the first operating state is conditioned on a trigger condition appearing on the graphical user interface while the processor is operating in the prior operating state; wherein the graphical user interface comprises multiple particular patterns; wherein each particular pattern comprises multiple symbol positions across the multiple columns; and wherein the trigger condition includes a landing of multiple special symbols within the multiple symbol positions.

EEE C13 is the computer-readable memory according to any one of EEE C9 to C12, wherein each particular pattern comprises three symbol positions across consecutive columns of the multiple columns.

EEE C14 is the computer-readable memory according to any one of EEE C9 to C12, wherein each pattern comprises three or more symbol positions across consecutive columns of the multiple columns.

EEE C15 is the computer-readable memory according to any one of EEE C13 or C14, wherein each pattern includes a symbol position in a left-most column of the multiple columns.

EEE C16 is the computer-readable memory according to any one of EEE C13 or C14, wherein each pattern includes a symbol position in a right-most column of the multiple columns.

EEE C17 is the computer-readable memory according to any one of EEE C1 to C16, wherein the functions further comprise: receiving, at an input device configured to input a payment amount, a first payment amount; wherein the processor is transitioned to a prior operating state in response to receiving the first payment amount.

EEE C18 is the computer-readable memory of EEE C17, wherein the input device includes an acceptor.

EEE C19 is the computer-readable memory of EEE C18, wherein the acceptor includes a paper money acceptor, a coin acceptor, a token acceptor, a validator, and/or a card reader.

EEE C20 is the computer-readable memory according to any one of EEE C17 to C19, wherein the input device includes a user-selectable control on a touch-sensitive screen of a display.

EEE C21 is the computer-readable memory according to any one of EEE C16 to C20, wherein the multiple special symbols function as scatter symbols.

EEE C22 is the computer-readable memory of EEE C21, wherein the scatter symbols effectuate a trigger event irrespective of positions of the scatter symbols among the multiple symbol positions.

EEE C23 is the computer-readable memory according to any one of EEE C16 to C22, wherein the multiple special symbols includes three or more special symbols.

EEE C24 is the computer-readable memory according to any one of EEE C16 to C23, wherein each special symbol of the multiple special symbols is identical in appearance to each other special symbol of the multiple special symbols.

EEE C25 is the computer-readable memory according to any one of EEE C1 to C24, wherein transitioning the processor from operating in the first operating state to the second operating state includes selecting the second reel set to use instead of the first reel set; wherein transitioning the processor from operating in the first operating state to the second operating state includes incrementing a spins counter by a predetermined number of spins; wherein transitioning the processor from operating in the first operating state to the second operating state includes outputting, on the graphical user interface, an icon indicating a quantity of spins indicated by the spins counter; and wherein transitioning the processor from operating in the first operating state to the second operating state includes activating a user selectable control selectable to initiate a next spin of spinnable reels in the multiple columns.

EEE C26 is the computer-readable memory of EEE C25, wherein providing the graphical user interface includes providing the graphical user interface on a touch display screen; and wherein the user selectable control selectable to initiate the next spin includes a user selectable control displayed on the touch display screen.

EEE C27 is the computer-readable memory of EEE C25, wherein providing the graphical user interface includes providing the graphical user interface on a display screen; and wherein the user selectable control selectable to initiate the next spin includes a user interface component remote from the display screen and operatively coupled to the processor.

EEE C28 is the computer-readable memory according to any one of EEE C1 to C27, wherein the second reward system includes multiple levels; wherein each level of the second reward system corresponds to a different reel set of the plurality of reel sets; and wherein the processor transitions to a different operating state for use with each different reel set of the plurality of reel sets.

EEE C29 is the computer-readable memory of EEE C28, wherein the multiple levels are ordered in a sequence beginning at a lowest level and ending at a greatest level.

EEE C30 is the computer-readable memory of EEE C29, wherein the multiple levels include one or more intermediary levels within the ordered sequence.

EEE C31 is the computer-readable memory of EEE C30, wherein a reward corresponding to reaching each level of the multiple levels of the second reward system includes a predetermined number of spins.

EEE C32 is the computer-readable memory of EEE C31, wherein a remaining number of spins is reset to the predetermined number of spins at each level of the second reward system.

EEE C33 is the computer-readable memory of EEE C32, wherein a remaining number of spins at each level of the second reward system is equal to the predetermined number of spins plus any free spins remaining in a previous level of the second reward system.

EEE C34 is the computer-readable memory to any one of EEE C32 to C33, wherein the predetermined number of spins at each level of the second reward system is different for two or more levels of the second reward system.

EEE C35 is the computer-readable memory according to any one of EEE C1 to C34, wherein the graphical user interface comprises multiple particular patterns, and wherein each particular pattern comprises multiple symbol positions across the multiple columns; wherein the processor determines for each particular pattern and each spin of the reels of the first reel set and each spin of the reels of the second reel set whether symbols in the symbol positions of the particular pattern form a winning pattern; and wherein the processor outputs a reward for the winning pattern.

EEE C36 is the computer-readable memory according to any one of EEE C1 to C35, wherein a reward associated with the first reward system provides a level upgrade in the second reward system.

EEE C37 is the computer-readable memory according to any one of EEE C1 to C36, wherein a reward associated with the first reward system is randomly chosen and/or modified from a predetermined list of available rewards corresponding to the first reward system.

EEE C38 is the computer-readable memory of EEE C37, wherein the predetermined list of available rewards corresponding to the first reward system includes one or more of additional free spins, additional collected special symbols, or activation of a special reward.

EEE C39 is the computer-readable memory according to any one of EEE C1 to C38, wherein the multiple rows include at least three rows.

EEE C40 is the computer-readable memory according to any one of EEE C1 to C39, wherein the multiple columns include at least three columns.

EEE C41 is the computer-readable memory according to any one of EEE C1 to C40, wherein the multiple columns include at least five columns, and wherein the multiple rows include at least three rows.

EEE C42 is the computer-readable memory according to any one of EEE C1 to C41, wherein a global symbol group stored in the computer-readable memory includes a plurality of symbols, subsets of which are displayable in a respective column of the multiple columns.

EEE C43 is the computer-readable memory according to any one of EEE C1 to C42, wherein a first plurality of symbols is randomly determined from the global symbol group; and wherein each of the first plurality of symbols is associated with one of the multiple symbol positions.

EEE C44 is the computer-readable memory according to any one of EEE C1 to C43, wherein the functions further comprise determining the second running total is less than the second threshold of the second reward system and a number of remaining spins in a spins counter for the second operating state is zero and then transitioning the processor to a next operating state; wherein the graphical user interface outputs an indication the processor is operating in the next operating state; and wherein a payment must be received while the processor operates in the next operating state before the processor transitions back to an operating state in which the processor is configured to output a reward based on spinning the reels.

EEE C45 is the computer-readable memory according to any one of EEE C1 to C44, wherein the second reward system includes multiple different levels; wherein the functions further comprise outputting, by the graphical user interface, while the processor operates in the first operating state, a level display that indicates a first level of the second reward system is a current level of the second reward system in use by the processor; and wherein the functions further comprise outputting, by the graphical user interface while the processor operates in the second operating state, the level display that indicates a second level of the second reward system is the current level of the second reward system in use by the processor.

EEE C46 is the computer-readable memory of EEE C45, wherein the multiple levels are ordered in a sequence beginning at a lowest level and ending at a greatest level.

EEE C47 is the computer-readable memory of EEE C46, wherein the current level of the second reward system is the lowest level.

EEE C48 is the computer-readable memory of EEE C46, wherein the current level of the second reward system is the greatest level.

EEE C49 is the computer-readable memory of EEE C46, wherein the multiple levels include one or more intermediary levels within the ordered sequence.

EEE C50 is the computer-readable memory of EEE C49, wherein the current level of the second reward system is an intermediary level.

EEE C51 is the computer-readable memory according to any one of EEE C43 to C50, wherein a primary reward is associated with each level of the multiple different levels of the second reward system.

EEE C52 is the computer-readable memory of EEE C51, wherein the primary reward associated with each level of the second reward system is different for different levels of the multiple levels of the second reward system.

EEE C53 is the computer-readable memory according to any one of EEE C51 to C52, wherein the primary award includes an award based on a payment amount entered using the computing system and a multiplier value.

EEE C54 is the computer-readable memory according to any one of EEE C1 to C53, wherein the computer-readable medium includes one or more from among: a spin meter value, a booster point value, a current level value, a token value, or a level threshold.

EEE C55 is the computer-readable memory according to any one of EEE C1 to C54, wherein transitioning the processor between two different operating states includes one or more from among: selecting a next reel set among the multiple reel sets, resetting a booster point value stored in the computer-readable medium, resetting a spin meter value stored in the computer-readable medium, resetting a token value stored in the computer-readable medium, selecting a next level threshold from among multiple level thresholds, changing a current level value stored in the computer-readable medium, or changing a current level display on the graphical user interface to indicate a level corresponding to the operating state to which the processor transitioned.

EEE C56 is the computer-readable memory according to any one of EEE C1 to C55, wherein the functions further include terminating an event that provides awards using the first reward system and the second reward system in response to determining a greatest level of the second reward system has been reached.

EEE C57 is the computer-readable memory according to any one of EEE C1 to C56, wherein the functions further include outputting a particular audible sound to indicate transitioning the processor from operating in the first operating state to the second operating state.

EEE C58 is the computer-readable memory according to any one of EEE C2 to C56, wherein the functions further include outputting a particular audible sound to indicate transitioning the processor from operating in the first operating state to the second operating state, and transitioning the processor from operating in the second operating state to the third operating state.

EEE C59 is the computer-readable memory according to any one of EEE C4 to C56, wherein the functions further include outputting a particular audible sound to indicate transitioning the processor from operating in the first operating state to the second operating state, transitioning the processor from operating in the second operating state to the third operating state, and transitioning the processor from operating in the third operating state to the fourth operating state.

EEE C60 is the computer-readable memory according to any one of EEE C1 to C59, wherein the functions further include outputting, by the graphical user interface, an indication of one or more from among: the processor changing operating states, a number of remaining free spins, a current level, a quantity of tokens needed to achieve a next level, a quantity of tokens needed to achieve a next booster point, a quantity of tokens received towards achieving the next level, a quantity of tokens received towards achieving the booster point, terminating an event that provides awards using the first reward system and the second reward system, or receiving an award.

1. A computing system comprising:
a processor; and
a computer-readable memory storing executable instructions, wherein execution of the executable instructions by the processor causes the computing system to perform functions, the functions include:
providing, by the processor, a graphical user interface comprising multiple symbol positions arranged in multiple rows and multiple columns, wherein:
each column of the multiple columns is arranged to depict a spinnable reel of a reel set,
each spinnable reel includes multiple different symbols from a set of symbols, and
the set of symbols includes a particular symbol;
outputting, on the graphical user interface while the processor operates in a first operating state, one or more spins of the reel set for the first operating state;
determining, by the processor based on the one or more spins of the reel set for the first operating state, a first running total of a number of times the particular symbol is displayed on the graphical user interface while the processor is operating in the first operating state;
determining, by the processor, whether the first running total exceeds one or more of a first threshold of a first reward system or a first threshold of a second reward system;
outputting, by the processor, at least one reward in response to the first running total exceeding one or more of the first threshold of the first reward system or the first threshold of the second reward system;
transitioning, in response to the first running total exceeding the first threshold of the second reward system, the processor from operating in the first operating state to a second operating state;
outputting, on the graphical user interface while the processor operates in the second operating state, one or more spins of the reel set for the second operating state;
determining, by the processor based on the one or more spins of the reel set for the second operating state, a second running total of a number of times the particular symbol is displayed on the graphical user interface while the processor is operating in the second operating state;
determining, by the processor, whether the second running total exceeds one or more of a second threshold of the first reward system or a second threshold of the second reward system; and
outputting, by the processor, at least one reward in response to the second running total exceeding one or more of the second threshold of the first reward system or the second threshold of the second reward system.

2. The computing system of claim 1, wherein the functions further include:
transitioning, in response to the second running total exceeding the second threshold of the second reward system, the processor from operating in the second operating state to a third operating state;
outputting, on the graphical user interface while the processor operates in the third operating state, one or more spins of the reel set for the third operating state;
determining, by the processor based on the one or more spins of the reel set for the third operating state, a third running total of a number of times the particular symbol is displayed on the graphical user interface while the processor is operating in the third operating state;
determining, by the processor, whether the third running total exceeds one or more of a third threshold of the first reward system or a third threshold of the second reward system;
outputting, by the processor, at least one reward in response to the third running total exceeding one or more of the third threshold of the first reward system or the third threshold of the second reward system.

3. The computing system of claim 2, wherein:
the third threshold of the second reward system is greater than the second threshold of the second reward system, and
the second threshold of the second reward system is greater than the first threshold of the second reward system.

4. The computing system of claim 2, wherein:
a plurality of reel sets includes a first reel set, a second reel set, and a third reel set,
each of the first reel set, the second reel set, and the third reel set include one or more different reels compared to reels of other reel sets of the first reel set, the second reel set, and the third reel set,
the different reels include different combinations of symbols,
the one or more spins of the reel set for the first operating state include one or more spins of the first reel set after selection of the first reel set for the first operating state,
the one or more spins of the reel set for the second operating state include one or more spins of the second reel set after selection of the second reel set for the second operating state, and
the one or more spins of the reel set for the third operating state include one or more spins of the third reel set after selection of the third reel set for the third operating state.

5. The computing system of claim 2, wherein the functions further include:
transitioning, in response to the third running total exceeding the third threshold of the second reward system, the processor from operating in the third operating state to a fourth operating state;
outputting, on the graphical user interface while the processor operates in the fourth operating state, one or more spins of a reel set for the fourth operating state;
determining, by the processor based on the one or more spins of the reel set for the fourth operating state, a fourth running total of a number of times the particular symbol is displayed on the graphical user interface while the processor is operating in the fourth operating state;
determining, by the processor, whether the fourth running total exceeds one or more of a fourth threshold of the first reward system or a fourth threshold of the second reward system;
outputting, by the processor, at least one reward in response to the fourth running total exceeding one or more of the fourth threshold of the first reward system or the fourth threshold of the second reward system.

6. The computing system of claim 5, wherein:
the fourth threshold of the second reward system is greater than the third threshold of the second reward system,
the third threshold of the second reward system is greater than the second threshold of the second reward system, and
the second threshold of the second reward system is greater than the first threshold of the second reward system.

7. The computing system of claim 5, wherein:
a plurality of reel sets includes a first reel set, a second reel set, a third reel set, and a fourth reel set,
each of the first reel set, the second reel set, the third reel set, and the fourth reel set include one or more different reels compared to reels of other reel sets of the first reel set, the second reel set, the third reel set, and the fourth reel set,
the different reels include different combinations of symbols,
the one or more spins of the reel set for the first operating state include one or more spins of the first reel set after selection of the first reel set for the first operating state,
the one or more spins of the reel set for the second operating state include one or more spins of the second reel set after selection of the second reel set for the second operating state,
the one or more spins of the reel set for the third operating state include one or more spins of the third reel set after selection of the third reel set for the third operating state, and
the one or more spins of the reel set for the fourth operating state include one or more spins of the fourth reel set after selection of the fourth reel set for the fourth operating state.

8. The computing system of claim 1, wherein:
a plurality of reel sets includes a first reel set and a second reel set,
the first reel set includes one or more different reels than the second reel set,
the different reels include different combinations of symbols,
the one or more spins of the reel set for the first operating state include one or more spins of the first reel set after selection of the first reel set for the first operating state, and
the one or more spins of the reel set for the second operating state include one or more spins of the second reel set after selection of the second reel set for the second operating state.

9. The computing system of claim 1, wherein:
the functions further include transitioning the processor from a prior operating state to the first operating state,
transitioning from the prior operating state to the first operating state is conditioned on a trigger condition appearing on the graphical user interface while the processor is operating in the prior operating state,
the graphical user interface comprises multiple particular patterns,
each particular pattern comprises multiple symbol positions across the multiple columns,
the trigger condition includes a particular combination of symbols from the set of symbols appearing within a particular pattern of the graphical user interface, and
the particular pattern includes a particular payline or a particular payway of the multiple particular patterns.

10. The computing system of claim 9, wherein each of the multiple particular patterns includes a horizontally extending pattern, a vertically extending pattern, a diagonally extending pattern, an angled pattern, a circular pattern, or a combination thereof.

11. The computing system of claim 1, wherein:
the functions further include transitioning the processor from a prior operating state to the first operating state,
transitioning from the prior operating state to the first operating state is conditioned on a trigger condition appearing on the graphical user interface while the processor is operating in the prior operating state,
the graphical user interface comprises multiple particular patterns,
each particular pattern comprises multiple symbol positions across the multiple columns, and
the trigger condition includes a landing of multiple special symbols within the multiple symbol positions.

12. The computing system of claim 11, wherein:
the multiple special symbols function as scatter symbols, and
the scatter symbols effectuate a trigger event irrespective of positions of the scatter symbols among the multiple symbol positions.

13. The computing system of claim 1, wherein the functions further include:
receiving, at an input device configured to input a payment amount, a first payment amount, and
transitioning the processor to a prior operating state in response to receiving the first payment amount.

14. A method comprising:
providing, by a processor, a graphical user interface comprising multiple symbol positions arranged in multiple rows and multiple columns, wherein:
each column of the multiple columns is arranged to depict a spinnable reel of a reel set,
each spinnable reel includes multiple different symbols from a set of symbols, and
the set of symbols includes a particular symbol;
outputting, on the graphical user interface while the processor operates in a first operating state, one or more spins of the reel set for the first operating state;
determining, by the processor based on the one or more spins of the reel set for the first operating state, a first running total of a number of times the particular symbol is displayed on the graphical user interface while the processor is operating in the first operating state;
determining, by the processor, whether the first running total exceeds one or more of a first threshold of a first reward system or a first threshold of a second reward system;
outputting, by the processor, at least one reward in response to the first running total exceeding one or more of the first threshold of the first reward system or the first threshold of the second reward system;
transitioning, in response to the first running total exceeding the first threshold of the second reward system, the processor from operating in the first operating state to a second operating state;
outputting, on the graphical user interface while the processor operates in the second operating state, one or more spins of the reel set for the second operating state;
determining, by the processor based on the one or more spins of the reel set for the second operating state, a second running total of a number of times the particular symbol is displayed on the graphical user interface while the processor is operating in the second operating state;
determining, by the processor, whether the second running total exceeds one or more of a second threshold of the first reward system or a second threshold of the second reward system; and
outputting, by the processor, at least one reward in response to the second running total exceeding one or more of the second threshold of the first reward system or the second threshold of the second reward system.

15. The method of claim 14, further comprising:
transitioning, in response to the second running total exceeding the second threshold of the second reward system, the processor from operating in the second operating state to a third operating state;
outputting, on the graphical user interface while the processor operates in the third operating state, one or more spins of the reel set for the third operating state;
determining, by the processor based on the one or more spins of the reel set for the third operating state, a third running total of a number of times the particular symbol is displayed on the graphical user interface while the processor is operating in the third operating state;
determining, by the processor, whether the third running total exceeds one or more of a third threshold of the first reward system or a third threshold of the second reward system; and
outputting, by the processor, at least one reward in response to the third running total exceeding one or more of the third threshold of the first reward system or the third threshold of the second reward system.

16. The method of claim 15, wherein:
a plurality of reel sets includes a first reel set, a second reel set, and a third reel set,
each of the first reel set, the second reel set, and the third reel set include one or more different reels compared to reels of other reel sets of the first reel set, the second reel set, and the third reel set,
the different reels include different combinations of symbols,
the one or more spins of the reel set for the first operating state include one or more spins of the first reel set after selection of the first reel set for the first operating state,
the one or more spins of the reel set for the second operating state include one or more spins of the second reel set after selection of the second reel set for the second operating state, and
the one or more spins of the reel set for the third operating state include one or more spins of the third reel set after selection of the third reel set for the third operating state.

17. The method of claim 15, further comprising:
transitioning, in response to the third running total exceeding the third threshold of the second reward system, the processor from operating in the third operating state to a fourth operating state;
outputting, on the graphical user interface while the processor operates in the fourth operating state, one or more spins of the reel set for the fourth operating state;
determining, by the processor based on the one or more spins of the reel set for the fourth operating state, a fourth running total of a number of times the particular symbol is displayed on the graphical user interface while the processor is operating in the fourth operating state;
determining, by the processor, whether the fourth running total exceeds one or more of a fourth threshold of the first reward system or a fourth threshold of the second reward system; and
outputting, by the processor, at least one reward in response to the fourth running total exceeding one or more of the fourth threshold of the first reward system or the fourth threshold of the second reward system.

18. The method of claim 17, wherein:
a plurality of reel sets includes a first reel set, a second reel set, a third reel set, and a fourth reel set,
each of the first reel set, the second reel set, the third reel set, and the fourth reel set include one or more different reels compared to reels of other reel sets of the first reel set, the second reel set, the third reel set, and the fourth reel set,
the different reels include different combinations of symbols,
the one or more spins of the reel set for the first operating state include one or more spins of the first reel set after selection of the first reel set for the first operating state,
the one or more spins of the reel set for the second operating state include one or more spins of the second reel set after selection of the second reel set for the second operating state,
the one or more spins of the reel set for the third operating state include one or more spins of the third reel set after selection of the third reel set for the third operating state, and
the one or more spins of the reel set for the fourth operating state include one or more spins of the fourth reel set after selection of the fourth reel set for the fourth operating state.

19. The method of claim 14, wherein:
a plurality of reel sets includes a first reel set and a second reel set,
the first reel set includes one or more different reels than the second reel set,
the different reels include different combinations of symbols,
the one or more spins of the reel set for the first operating state include one or more spins of the first reel set after selection of the first reel set for the first operating state, and
the one or more spins of the reel set for the second operating state include one or more spins of the second reel set after selection of the second reel set for the second operating state.

20. The method of claim 14, further comprising:
receiving, at an input device configured to input a payment amount, a first payment amount; and
transitioning the processor to a prior operating state in response to receiving the first payment amount.

21. A non-transitory computer-readable memory having stored therein instructions executable by a processor to cause a computing system to perform functions comprising:
providing, by the processor, a graphical user interface comprising multiple symbol positions arranged in multiple rows and multiple columns, wherein:
each column of the multiple columns is arranged to depict a spinnable reel of a reel set,
each spinnable reel includes multiple different symbols from a set of symbols, and
the set of symbols includes a particular symbol;
outputting, on the graphical user interface while the processor operates in a first operating state, one or more spins of the reel set for the first operating state;
determining, by the processor based on the one or more spins of the reel set for the first operating state, a first running total of a number of times the particular symbol is displayed on the graphical user interface while the processor is operating in the first operating state;
determining, by the processor, whether the first running total exceeds one or more of a first threshold of a first reward system or a first threshold of a second reward system;
outputting, by the processor, at least one reward in response to the first running total exceeding one or more of the first threshold of the first reward system or the first threshold of the second reward system;
transitioning, in response to the first running total exceeding the first threshold of the second reward system, the processor from operating in the first operating state to a second operating state;
outputting, on the graphical user interface while the processor operates in the second operating state, one or more spins of the reel set for the second operating state;
determining, by the processor based on the one or more spins of the reel set for the second operating state, a second running total of a number of times the particular symbol is displayed on the graphical user interface while the processor is operating in the second operating state;
determining, by the processor, whether the second running total exceeds one or more of a second threshold of the first reward system or a second threshold of the second reward system; and
outputting, by the processor, at least one reward in response to the second running total exceeding one or more of the second threshold of the first reward system or the second threshold of the second reward system.

22. The non-transitory computer-readable memory of claim 21, wherein:
the functions further comprise transitioning the processor from a prior operating state to the first operating state,
transitioning from the prior operating state to the first operating state is conditioned on a trigger condition appearing on the graphical user interface while the processor is operating in the prior operating state,
the graphical user interface comprises multiple particular patterns,
each particular pattern comprises multiple symbol positions across the multiple columns,
the trigger condition includes a particular combination of symbols from the set of symbols appearing within a particular pattern of the graphical user interface, and
the particular pattern includes a particular payline of the multiple particular patterns.

23. The non-transitory computer-readable memory of claim 21, wherein:
the functions further comprise transitioning the processor from a prior operating state to the first operating state,
transitioning from the prior operating state to the first operating state is conditioned on a trigger condition appearing on the graphical user interface while the processor is operating in the prior operating state,
the graphical user interface comprises multiple particular patterns,
each particular pattern comprises multiple symbol positions across the multiple columns,
the trigger condition includes a particular combination of symbols from the set of symbols appearing within a particular pattern of the graphical user interface, and
the particular pattern includes a particular payway of the multiple particular patterns.

24. The non-transitory computer-readable memory of claim 21, wherein:
the functions further comprise transitioning the processor from a prior operating state to the first operating state,
transitioning from the prior operating state to the first operating state is conditioned on a trigger condition appearing on the graphical user interface while the processor is operating in the prior operating state,
the graphical user interface comprises multiple particular patterns,
each particular pattern comprises multiple symbol positions across the multiple columns, and
the trigger condition includes a landing of multiple special symbols within the multiple symbol positions.

25. The non-transitory computer-readable memory of claim 21, wherein:
a plurality of reel sets includes a first reel set and a second reel set,
the first reel set includes one or more different reels than the second reel set,
the different reels include different combinations of symbols,
the one or more spins of the reel set for the first operating state include one or more spins of the first reel set after selection of the first reel set for the first operating state, and
the one or more spins of the reel set for the second operating state include one or more spins of the second reel set after selection of the second reel set for the second operating state.
